(19) United States
(12) Patent Application Publication
(10) Pub. No.: US 2026/0111391 A1
(43) Pub. Date: Apr. 23, 2026

(54) METHODS AND APPARATUS FOR VECTOR LANE MATRIX MULTIPLICATION

(71) Applicant: Openchip & Software Technologies S.L., Barcelona (ES)

(72) Inventors: Erich Ludwig Focht, Stuttgart (DE); Massimo Scardaci, Catania (IT)

(21) Appl. No.: 19/345,393

(22) Filed: Sep. 30, 2025

Related U.S. Application Data
(63) Continuation of application No. PCT/EP2025/071258, filed on Jul. 23, 2025.

(30) Foreign Application Priority Data
Jul. 23, 2025 (WO) PCT/EP2025/071258

(51) Int. Cl. G06F 15/173

(52) U.S. Cl. CPC G06F 15/17375

(57) ABSTRACT

Systems, apparatus, articles of manufacture, and methods are disclosed. An example apparatus includes a Vector Processor Unit (VPU) comprising: first vector lane circuitry including first matrix multiplier circuitry; second vector lane circuitry including second matrix multiplier circuitry; and interconnect circuitry to connect the first vector lane circuitry and the second vector lane circuitry in a ring structure.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to matrix multiplication and, more particularly, to methods and apparatus for matrix multiplication.

### BACKGROUND

In recent years, computations workloads have become increasingly reliant on large amounts of parallel operations. A Vector Processing Unit (VPU) is a type of programmable circuitry that supports parallelism with Single Instruction, Multiple Data (SIMD) processing. VPUs can increase the efficiency of executing certain applications (e.g., training or executing machine learning models, graphics rendering for media or video games, etc.) compared to other types of programmable circuitry.

### BRIEF DESCRIPTION OF THE DRAWINGS

FIG. 1 is a block diagram of an example environment in which an example Vector Processing Unit (VPU) operates to perform matrix multiplication.

FIG. 2 is a block diagram of an example implementation of the VPU of FIG. 1.

FIG. 3A is a first example block diagram of an example implementation of the vector lane circuitry of FIG. 2.

FIG. 3B is a second example block diagram of an example implementation of the vector lane circuitry of FIG. 2.

FIG. 4 is an illustrative example of matrices, tiles, and sub-tiles.

FIGS. 5A-5F are a first illustrative example of matrix multiplication operations performed by the VPU of FIG. 2.

FIGS. 6A-6C are a second illustrative example of matrix multiplication operations performed by the VPU of FIG. 2.

FIGS. 7A-7C are a third illustrative example of matrix multiplication operations performed by the VPU of FIG. 2.

FIG. 8 are first and second example implementations of the matrix multiplier circuitry of FIGS. 3A and 3B.

FIG. 9A is a first example implementation of the column buffer circuitry and row buffer circuitry of FIG. 3B.

FIG. 9B is a second example implementation of the column buffer circuitry and row buffer circuitry of FIG. 3B.

FIG. 10 is an illustrative example of pseudocode used to implement outer product matrix multiplication and inner product matrix multiplication.

FIG. 11 is an illustrative example of instructions from an Instruction Set Architecture (ISA) that supports the matrix multiplier circuitry of FIG. 2.

FIG. 12 is an illustrative example of the tile structure argument used in FIG. 11.

FIG. 13 is an illustrative example of instructions within the reduced instruction set computer (RISC)—V ISA that support the matrix multiplier circuitry of FIG. 2.

FIG. 14 is an illustrative example of machine-readable instructions that implement an execution plan for the VPU of FIG. 1.

FIG. 15 is a flowchart representative of example machine-readable instructions and/or example operations that may be executed, instantiated, and/or performed by example programmable circuitry to implement matrix multiplication in the VPU of FIG. 2.

FIG. 16 illustrates an example hardware arrangement of an example data center.

FIG. 17A illustrates an example arrangement of an example chip assembly of FIG. 16

FIG. 17B illustrates an example arrangement of an example chip assembly of FIG. 16, adapted for high-performance computing applications.

FIG. 18 is a block diagram of an example processing platform including programmable circuitry structured to execute, instantiate, and/or perform the example machine-readable instructions and/or perform the example operations of FIG. 15 to implement the compute device 100 of FIG. 1.

FIG. 19 is a block diagram of an example implementation of the programmable circuitry of FIG. 18.

FIG. 20 is a block diagram of another example implementation of the programmable circuitry of FIG. 18.

FIG. 21 is a block diagram of an example software/firmware/instructions distribution platform (e.g., one or more servers) to distribute software, instructions, and/or firmware (e.g., corresponding to the example machine-readable instructions of FIG. 15) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

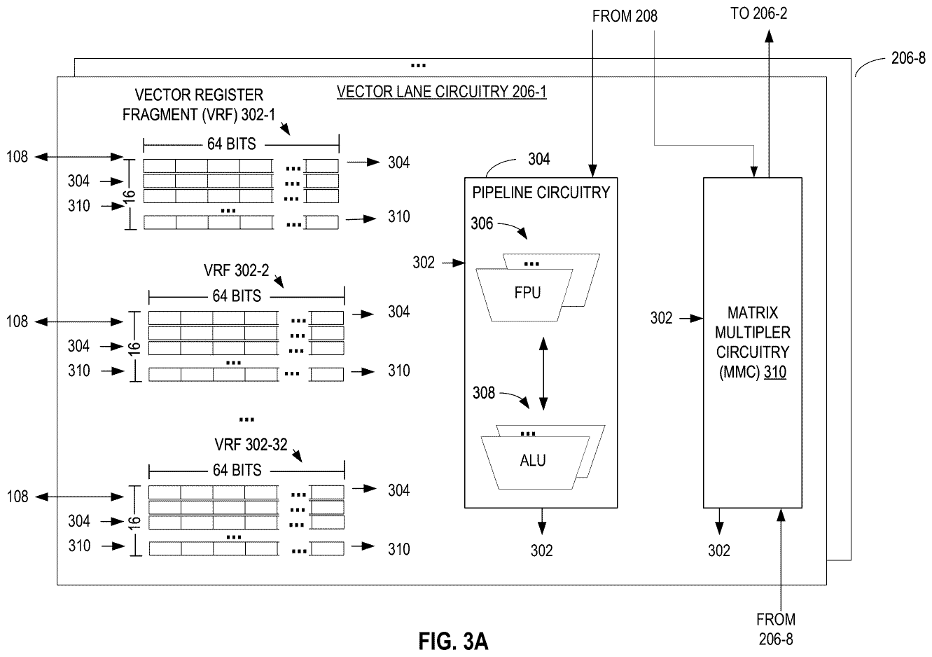

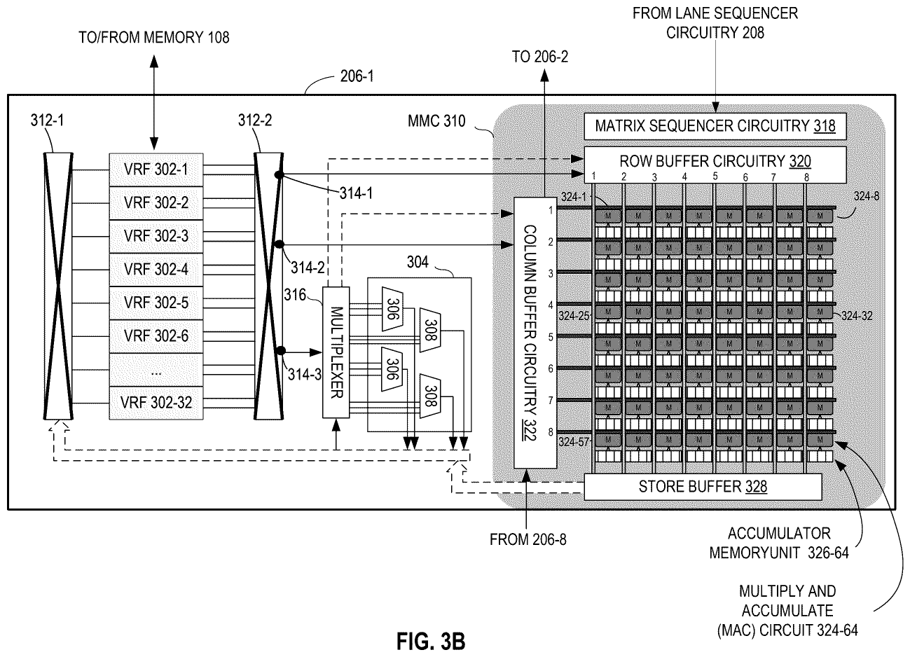

A VPU may include a group of processor circuits that implement vector lanes. A vector lane includes memory and a series of arithmetic logic units that form a pipeline. VPUs with vector lanes generally support workloads with high degrees of parallelism by running multiple execution pipelines (e.g., multiple hardware threads, or multiple virtual machines) in parallel with one another. Vector lanes are described further in connection with FIG. 3.

Many applications that rely on large amounts of parallel operations also rely on matrix multiplication to manipulate extremely large amounts of data. As a first example, some machine learning model training procedures include a process called propagation in which matrices that store activation parameters are multiplied with matrices that store weight parameters. The total number of parameters may vary based on the particular model but are generally on a scale between millions of parameters (for smaller models) and billions of parameters (for larger models). For instance, GPT-3, a Large Language Model (LLM) developed by OpenAI® has, approximately 175 billion parameters organized into approximately 28,0000 matrices. As a second example, graphics rendering for media or video games may include generating a photorealistic or non-photorealistic image from input data such as 3D models. These 3D models frequently use matrix multiplication to manipulate millions or billions of parameters for operations such as defining geometries and relative distances in the scenes with point clouds, computing how light falls on a particular surface, etc. More generally, applications that rely on matrix multiplication to manipulate large quantities of data can be found in a wide variety of use cases.

As used above and herein, a matrix refers to an array of quantities or elements. A matrix is generally described by dimensions that include a number of rows and a number of columns or other equivalent expression.

Some VPUs support such matrix operations by implementing one or more matrix multiplier circuits separately and independently from the vector lane circuits. As described further below, a matrix multiplier circuit performs matrix multiplication using a grid of logic circuits (e.g., Multiply-And-Accumulate (MAC) units, Fuse-Multiply-Add (FMA) units, etc.). These matrix multiplication arrays are comparatively large because they receive data from, and therefore connect to, each of the vector lanes in the VPU. For example, some matrix multiplier circuits in some VPUs have a [128×128] grid of logic units (for a total of over 16,0000 logic units). Such a large consolidation of logic units in a single area decreases flexibility of where the matrix multiplier circuitry can be positioned on an Integrated Circuit (IC), thereby increasing the cost and complexity of the IC design process. In many examples, the large size of the matrix multiplier circuitry in some VPUs causes the matrix multiplier circuitry to be physically located a comparatively far distance from the memory circuits in the vector lanes (where the matrix multiplier circuitry both receives input data from and transmits output data to). Accordingly, some VPUs utilize comparatively long interconnects to couple the memory circuits in the vector lanes to the matrix multiplier circuitry. These long interconnects can increase data transfer latency, add noise to the system, consume additional power, and consume additional space within the IC. As such, the performance of some VPUs is limited by, and the cost and complexity of some VPUs are exacerbated by, large matrix multiplier circuits that are implemented externally from the vector lanes.

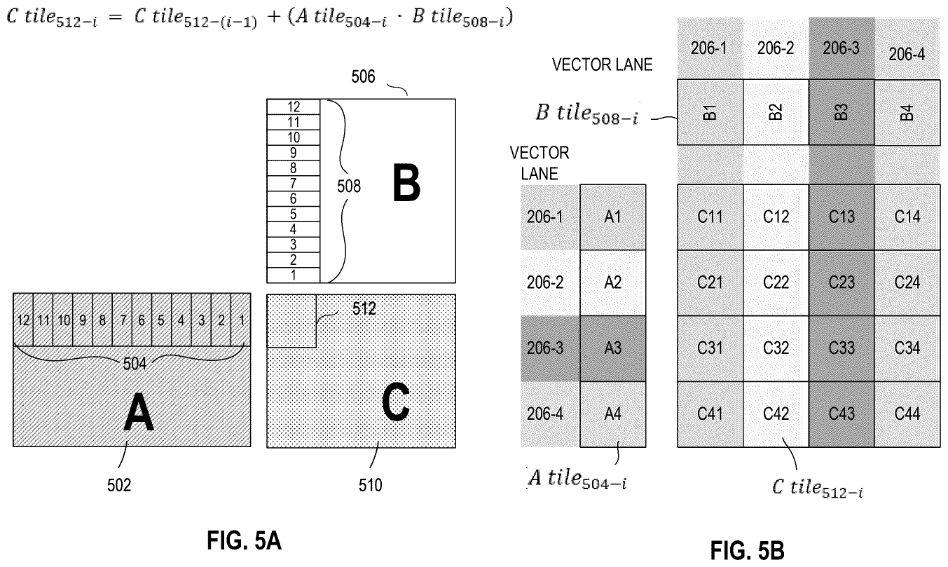

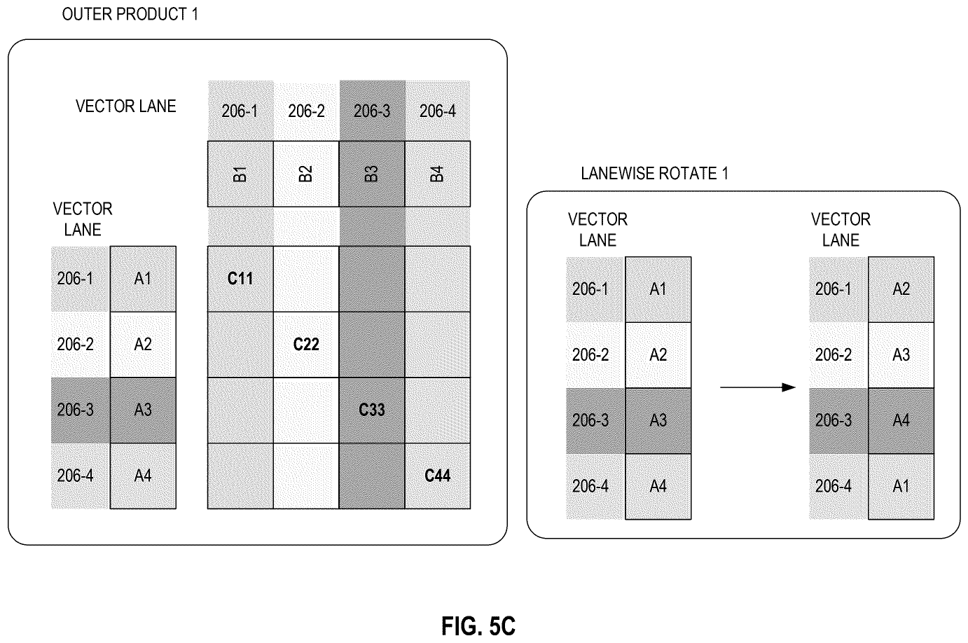

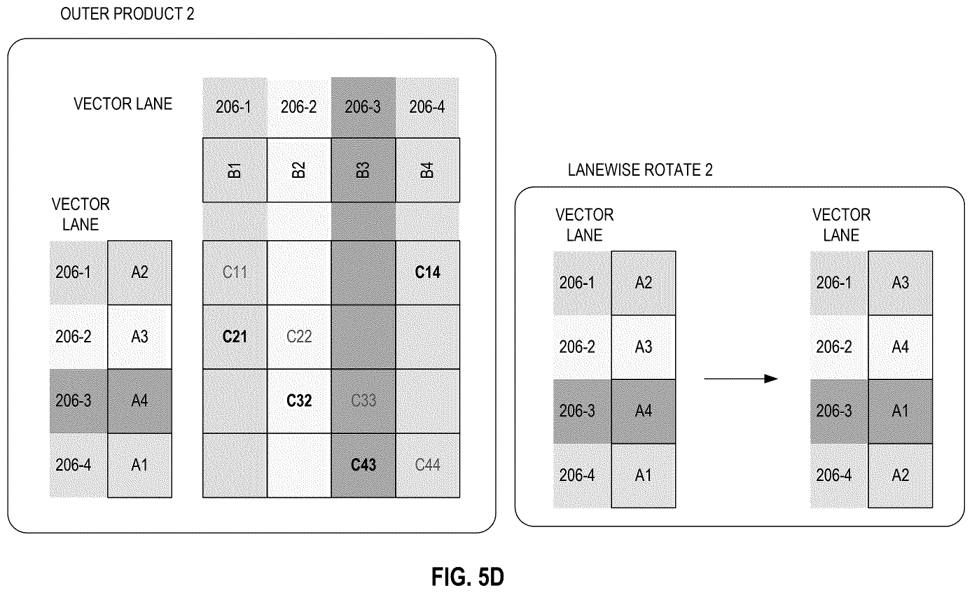

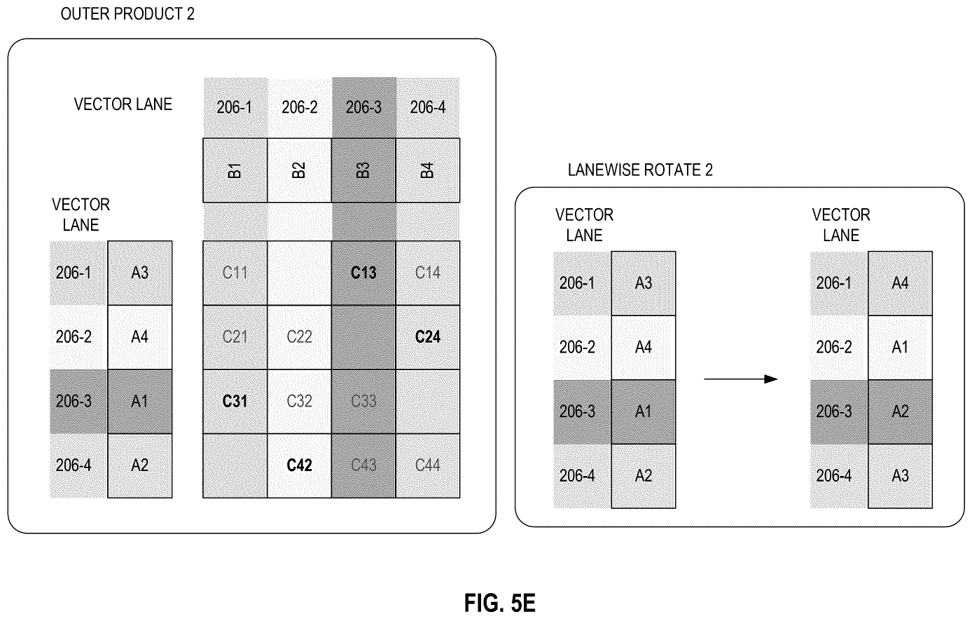

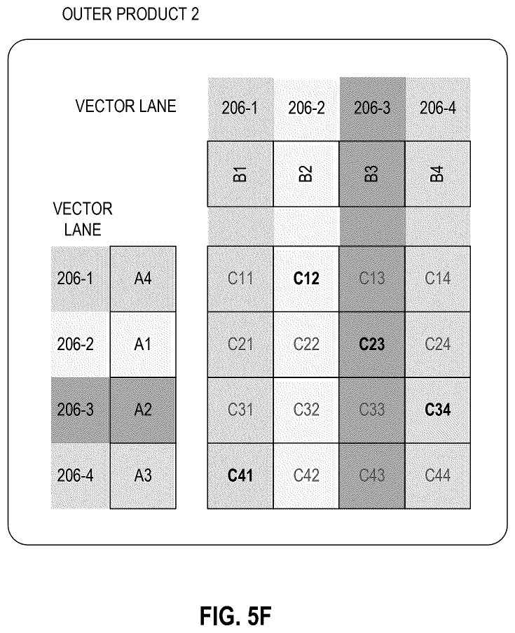

Example methods, apparatus, and systems disclosed herein implement VPUs that support matrix multiplication without the use of large external matrix multiplier circuits. Instead, a given vector lane within an example VPU described herein includes a comparatively small matrix multiplier circuit, which operates in concert with the matrix multiplier circuits of other vector lanes to implement matrix multiplication. For example, the matrix multiplier circuitry described further below in FIG. 5 is located within a single vector lane and has a total of 64 logic units (as opposed to the over 16,000 logic units described above in known VPUs). Example VPUs described herein therefore have lower cost, lower power consumption, and lower complexity than known VPUs because the IC design of an example VPUs described herein does not require the inclusion of a large external matrix multiplier circuit. Example VPUs described herein also do not include the comparatively large interconnects between memory circuits of the vector lanes and a large external matrix multiplier circuit. Instead, example VPUs described herein implement comparatively small interconnects between subsequent vector lanes so that matrix data can flow between the vector lanes in a ring. The reduction in interconnect length reduces data transfer latency, power consumption, and noise in the example VPUs described herein compared to other VPUs.

In general, a user space application communicates with a VPU by generating instructions that are compliant with an instruction set architecture (ISA). Accordingly, a user space application can use an example ISA described herein to change how data is transferred into and shared between the respective matrix multiplier circuits, thereby enabling high arithmetic intensity regardless of what input matrix dimensions are provided by the user space application. Thus, example VPUs disclosed herein can achieve higher performance, lower cost, and lower complexity than other VPUs while still providing support for a wide variety of matrix multiplication use cases at high efficiency.

The following introduces examples of computer hardware for matrix multiplication operations, applicable in programmable architectures such as chiplet-based processors, System-on-chip (SoC) circuitry, System-in-Package (SiP) or System-on-Package (SoP) circuitry, and/or any other modular packaging implementations of programmable circuitry.

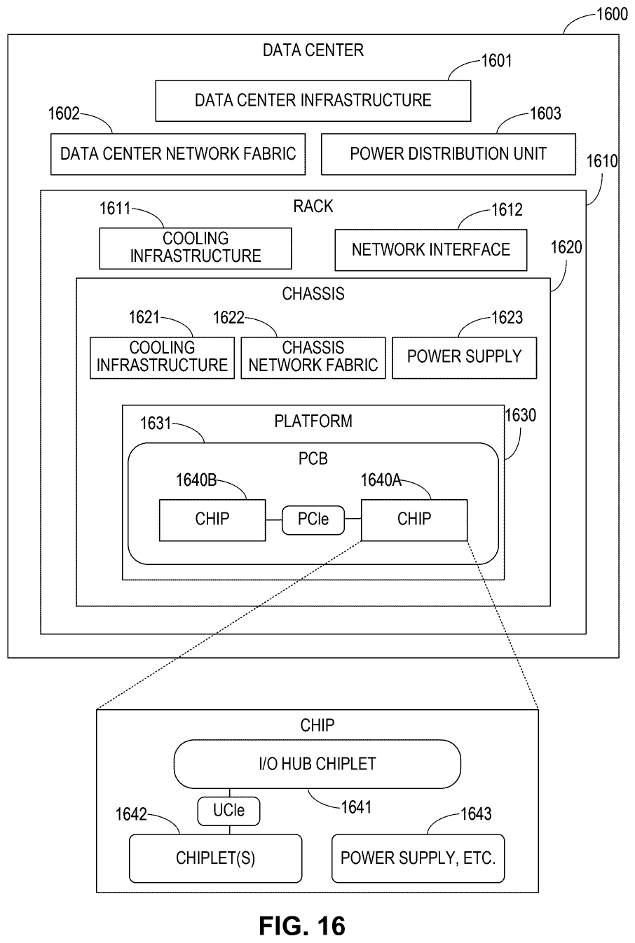

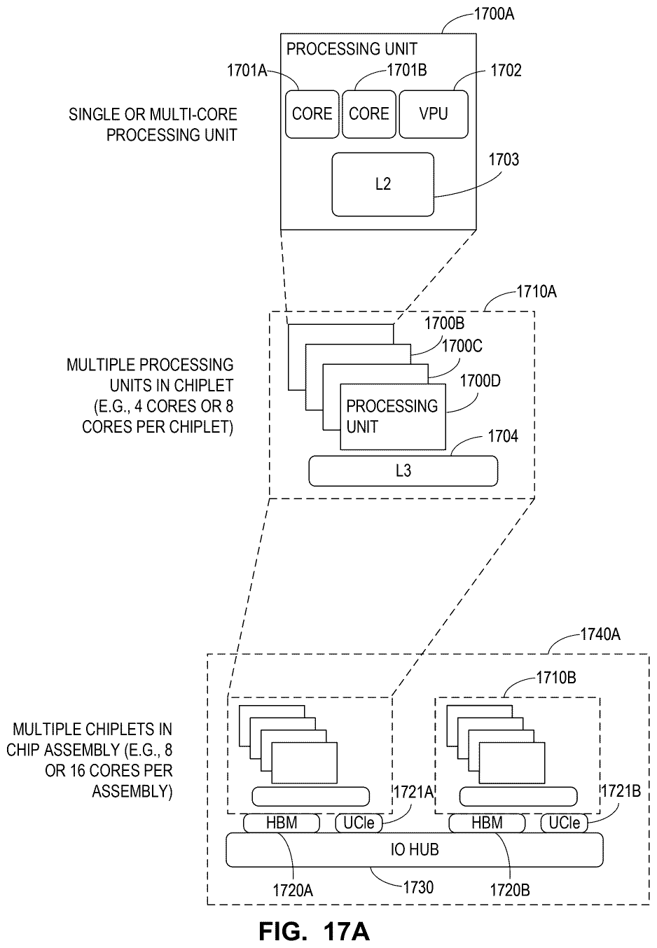

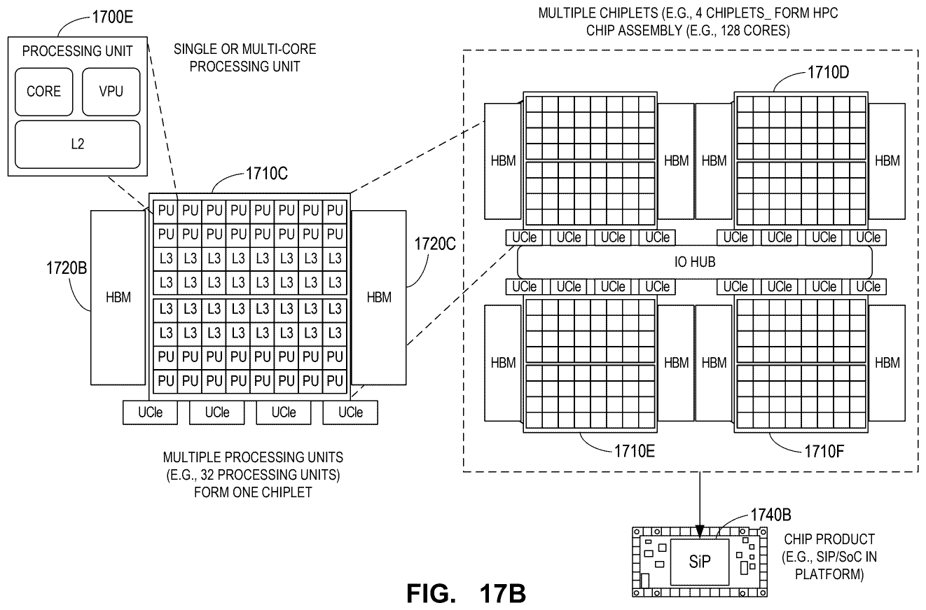

As used herein, a chiplet refers to any integrated circuit (IC) that has a modular structure designed to have one or more specified functionalities and to be combinable with one or more other chiplets on an interposer or other substrate in a package. Examples of chiplets are compute chiplets that include programmable circuitry (e.g., one or more processor circuits, such as one or more cores, etc.) and supporting circuitry (e.g., local memory, etc.) to provide computational functionality (e.g., to execute a host OS, applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers. Example implementation of chiplets are further described below in conjunction with FIGS. 16, 17A, and 17B.

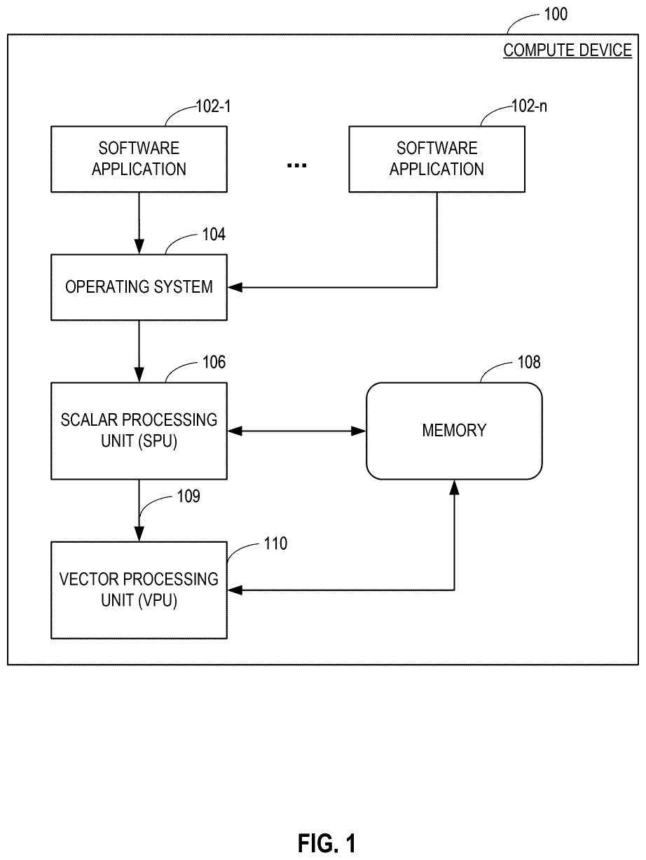

FIG. 1 is a block diagram of an example compute device 100. FIG. 1 shows the compute device 100 includes example software applications 102-1, . . . , 102-n (referred to collectively as software applications 102), an example operating system 104, an example Scalar Processing Unit (SPU) 106, example memory 108, example vector instructions 109, and an example Vector Processing Unit (VPU) 110. In some examples, one or more of the components of FIG. 1 may be implemented on multiple different compute devices. For example, the VPU 110 may receive instructions from any number of software applications 102 as described further below, and any number of the software applications 102 may be implemented on the same or different compute device as the VPU 110.

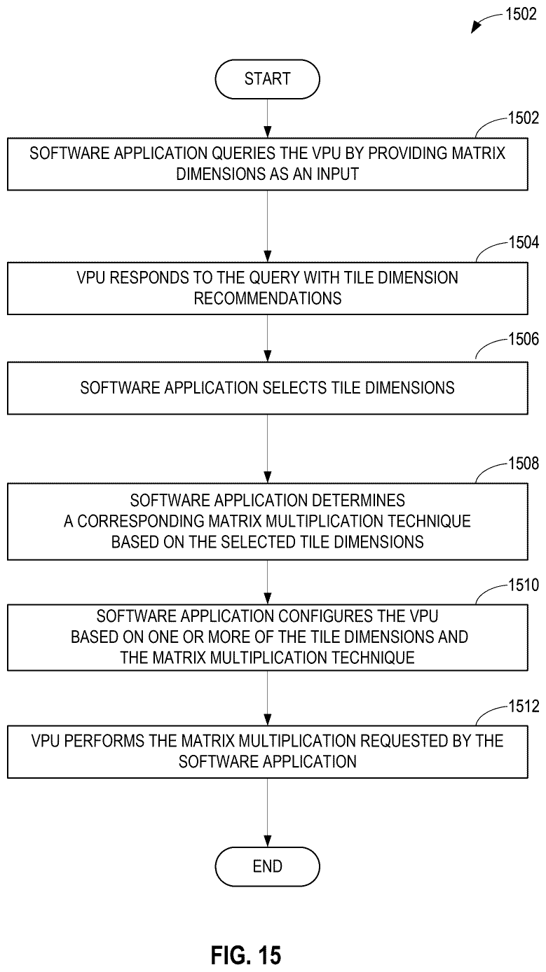

The software applications 102 are programs that cause performance of tasks on the compute device 100. The tasks may correspond to any use case, support any amount of parallelization and include any amount of matrix multiplication. When requesting performance of a task that includes matrix multiplication, a given software application 102-1 define the size and contents of the input matrices and coordinate how the VPU 110 performs the matrix multiplication. The software application 102-1 coordinates the matrix multiplication by providing instructions to the VPU 110 that are compliant with an example ISA described further below. In some examples, the software applications 102 are referred to as user space programs because they receive inputs from and/or provide outputs to users through interface devices such as a display, a keyboard, a mouse, etc. The compute device 100 may include any number of software applications 102. The software applications 102 cause performance of tasks by providing instructions to the operating system 104. In some examples, the software applications 102 are instantiated by programmable circuitry executing software application instructions and/or configured to perform operations such as those represented by the flowchart(s) of FIG. 15.

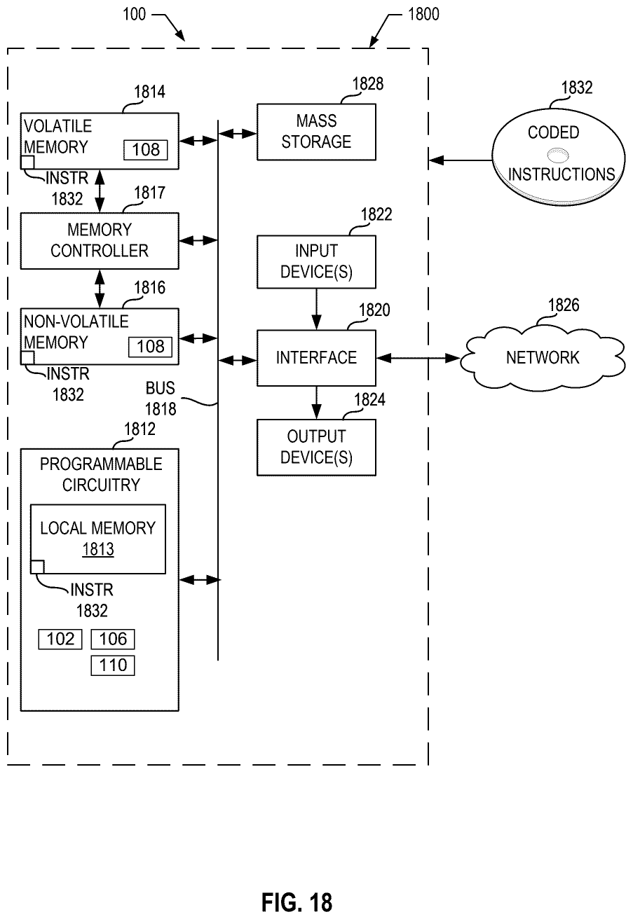

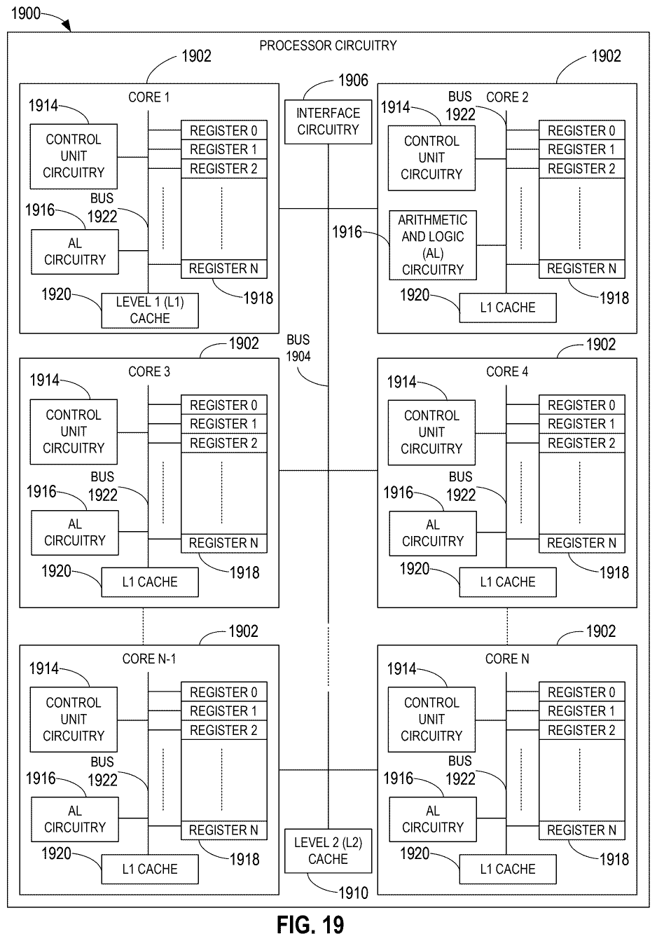

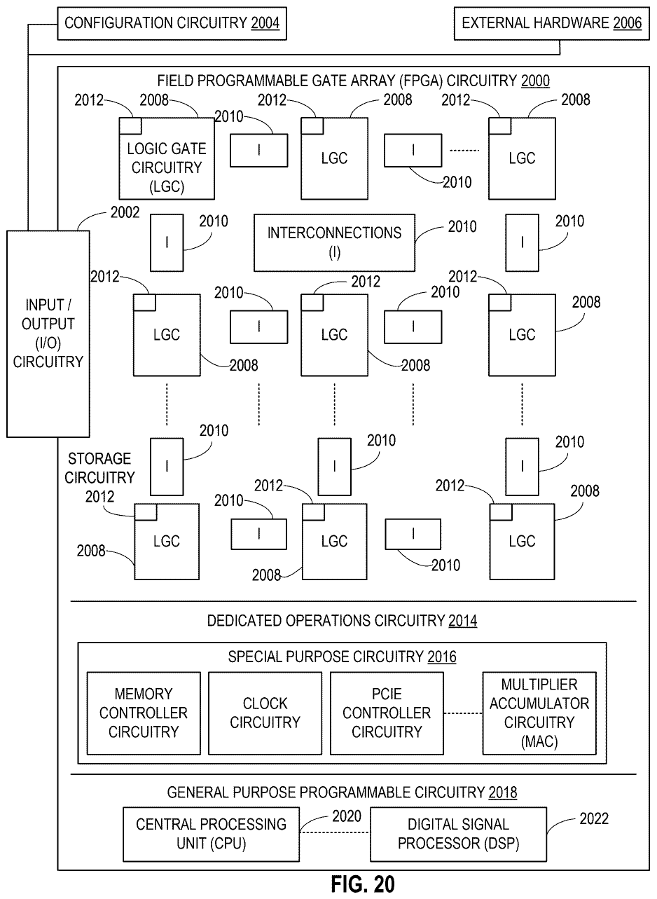

In some examples, the compute device 100 includes means for coordinating matrix multiplication. For example, the means for coordinating may be implemented by the software applications 102. In some examples, the software applications 102 may be instantiated by programmable circuitry such as the example programmable circuitry 1812 of FIG. 18. For instance, the software applications 102 may be instantiated by the example microprocessor 1900 of FIG. 19 and/or the chiplet of FIGS. 17A and/or 17B executing machine executable instructions such as those implemented by at least blocks 1502, 1506, 1508, 1510 of FIG. 15. In some examples, the software applications 102 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the software applications 102 may be instantiated by any other combination of hardware, software, and/or firmware. For example, the software applications 102 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The operating system 104 manages the hardware resources of the compute device 100 to execute the instructions defined by the software applications 102. For example, the operating system 104 may amend, convert, reorder, or otherwise edit the instructions of the software applications 102 to generate a stream of instructions that are interpretable by the SPU 106 and/or VPU 110. Thus, the stream of instructions generated by the operating system 104 are compliant with the ISA that corresponds to the VPU 110. The operating system 104 also analyzes the data dependency of the instructions from the software applications 102 to schedule the stream of instructions in a manner that mitigates race conditions.

In some examples, a given instruction in the stream of instructions can be categorized as either a scalar instruction or a vector instruction. In some examples, the operating system 104 determines whether a given instruction is scalar or vector. In some examples, the software applications 102 designate which tasks correspond to scalar instructions and which tasks correspond to vector instructions. The operating system 104 provides the stream of instructions (e.g., both the scalar and the vector instructions 109) to the SPU 106.

In this example, the SPU 106 refers to programmable circuitry that performs Single Instruction, Single Data (SISD) processing. The SPU may be implemented, for example, by a Central Processing Unit (CPU). The SPU 106 executes the scalar instructions received from the operating system 104 by reading data from the memory 108, performing operations on the data, and storing the results back in the memory 108. The SPU 106 also forwards the vector instructions 109 received from the operating system 104 to the VPU 110.

The memory 108 stores data used by the SPU 106 and/or the VPU 110 to perform the tasks defined by the software applications 102. The memory 108 may be implemented as any type of memory. For example, the memory 108 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

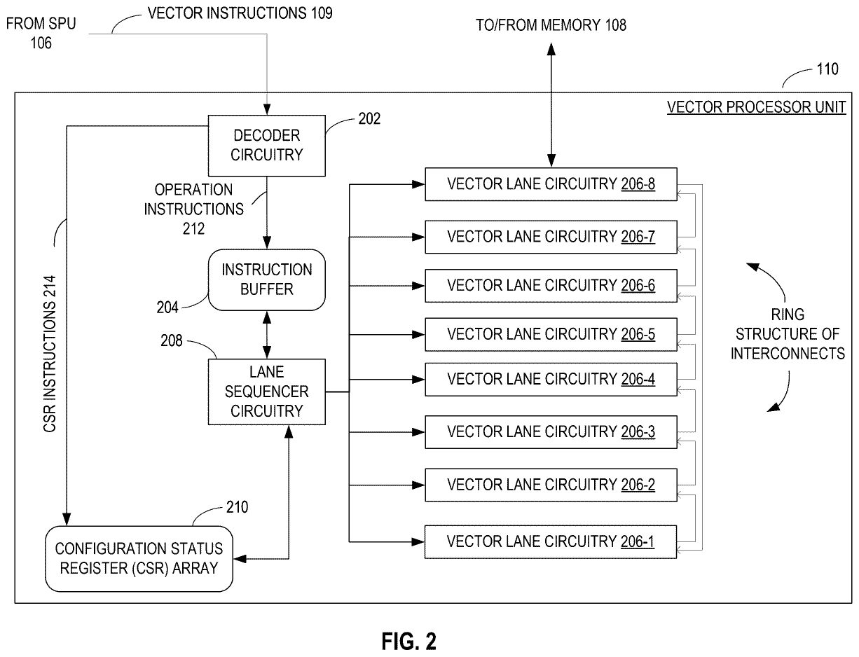

The VPU 110 refers to programmable circuitry that implements SIMD processing in accordance with the teachings described herein. To do so, the VPU 110 uses vector lanes (which include matrix multiplier circuits) to perform operations described by the vector instructions. The VPU 110 also reads data from the memory 108 before the operations are performed and writes data to the memory 108 to store the results of the operations. Collectively, the operations performed by the VPU 110 and SPU 106 accomplish the tasks described by the software applications 102. The VPU 110 is described further in connection with FIGS. 2-9. In some examples, the VPU 110 is instantiated by programmable circuitry executing VPU instructions and/or configured to perform operations such as those represented by the flowchart(s) of FIG. 15.

In some examples, the compute device 100 includes means for implementing matrix multiplication. For example, the means for implementing may be implemented by the VPU 110. In some examples, the VPU 110 may be instantiated by programmable circuitry such as the example programmable circuitry 1812 of FIG. 18. For instance, the VPU 110 may be instantiated by the example microprocessor 1900 of FIG. 19 and/or the chiplet of FIGS. 17A and/or 17B executing machine executable instructions such as those implemented by at least blocks 1504, 1512 of FIG. 15. In some examples, the VPU 110 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the VPU 110 may be instantiated by any other combination of hardware, software, and/or firmware. For example, the VPU 110 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 2 is a block diagram of a first example implementation of the VPU 110 of FIG. 1. In the example of FIG. 2, the VPU 110 includes example decoder circuitry 202, an example instruction buffer 204, example vector lane circuitry 206-1 through 206-8 (referred to collectively as vector lanes 206), example lane sequencer circuitry 208, and an example configuration status register (CSR) array 210. FIG. 2 also includes example operation instructions 212 and example CSR instructions 214.

The VPU 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the VPU 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The decoder circuitry 202 decodes a stream of vector instructions from the SPU 106 into one of the operation instructions 212, the VPU context instructions 216, and/or the CSR instructions 214. The operation instructions 212 within the vector instructions 109 describe operations for the vector lanes 206 to perform. The decoder circuitry 202 stores the operation instructions 212 in the instruction buffer 204 until the appropriate one or more of the vector lanes 206 are ready to perform the corresponding operations. In some examples, the decoder circuitry 202 is instantiated by programmable circuitry executing decoder instructions and/or configured to perform operations such as those represented by the flowchart(s) of FIG. 15.

The vector lanes 206 perform operations in parallel with one another to execute the operation instructions 212. The vector lanes 206 receive operation instructions 212 from the lane sequencer circuitry 208. The vector lanes 206 also exchange data to and from the memory 108 that is used to execute the operation instructions 212 and store the subsequent results. The vector lanes also couple to one another in a ring structure such that a sequence forms between vector lane circuits 206. A given vector lane circuit (e.g., 206-4) within a sequence formed by a rings structure of interconnects has both a previous vector lane circuit (e.g., 206-3) and a next vector lane circuit (e.g., 206-5). In some examples, the ring structure is referred to as a circular buffer. The ring structure can be implemented with comparatively short interconnects as described above. The vector lanes 206 and ring structure are described further in connection with FIGS. 3A and 3B. In some examples, the vector lanes 206 are instantiated by programmable circuitry executing vector lane instructions and/or configured to perform operations such as those represented by the flowchart(s) of FIG. 15.

FIG. 2 shows a single ring structure of interconnects that connects the vector lanes 206 in the VPU 110. However, in some examples, only a subset of the vector lanes 206 are assigned to perform matrix multiplication as described further below. Accordingly, in some examples, the VPU 110 has additional interconnects between the vector lanes 206 such that a functional ring structure exists between various subsets of vector lanes that may be assigned to perform matrix multiplication together. For further flexibility in some examples, a given vector lane (e.g., 206-1) includes an incoming and outgoing connection to every other vector lane in the VPU (e.g., 206-2 through 206-7) so that matrix multiplication operations can support any possible sequence of vector lanes (because a supporting ring structure of interconnects exists for any subset of vector lanes). More generally, example VPUs described herein implement at least one ring structure of interconnects between a group of vector lanes and may implement additional interconnects for additional flexibility.

The lane sequencer circuitry 208 determines how the operation instructions 212 are distributed to the vector lanes 206 for execution. The lane sequencer circuitry 208 assigns the operation instructions 212 to the vector lanes 206 based on the CSR array 210. The CSR array 210 may contain any data that describes the configuration and/or the current status of the vector lanes 206. Such information includes but is not limited to when a vector lane becomes available after completing a previous instruction. The lane sequencer circuitry 208 may consider other factors when distributing an operation instruction. Such factors include but are not limited to the contents of the operation instruction, the amount of data in the operation instruction, etc. In some examples, the lane sequencer circuitry 208 is instantiated by programmable circuitry executing sequencer instructions and/or configured to perform operations such as those represented by the flowchart(s) of FIG. 15.

In some examples, the decoder circuitry 202 populates the CSR array 210 based on the CSR instructions 214. Thus, in such examples, the assignment of operation instructions 212 to vector lanes 206 is configurable by an external source such as the software applications 102 or operating system 104. In some examples, the contents of the CSR 212 are preprogrammed into the VPU 110.

FIG. 3A is an example implementation of vector lane circuitry from the VPU 110 of FIG. 2. FIG. 3A shows the vector lane circuitry 206-1 includes example Vector Register Fragments (VRFs) 302-1, 302-2, . . . , 302-32 (collectively referred to as VRFs 302), example pipeline circuitry 304, and example matrix multiplier circuitry (MMC) 310. The pipeline circuitry 304 includes example Floating Point Operating Units (FPUs) 306 and example Arithmetic Logic Units (ALUs) 308. While FIG. 3A is described below with reference to the vector lane circuitry 206-1, the vector lane circuitry 206-2, . . . , 208-8 may also be implemented with the similar components as shown in FIG. 3A and operate as described below.

The VRFs 302 are portions of memory that act as a low-level cache for the pipeline circuitry 304 and matrix multiplier circuitry 310. In this example, a given VRF 302-1 is composed of 16 rows that each contains 64 bits. In some examples, the VRFs 302 have different dimensions.

The VPU 110 loads data from a specific address in main memory 108 to a specific VRF (e.g., 302-1) based on vector load instructions that are forwarded from the SPU 106. The pipeline circuitry 304 and the matrix multiplier circuitry 310 both obtain operation instructions from the lane sequencer circuitry 208. Once a particular set of VRFs (e.g. 302-1 and 302-2) are fully loaded with data from the memory 108 that corresponds to a given operation instruction, one or both of the pipeline circuitry 304 and the matrix multiplier circuitry 310 can implement the operation instruction by reading the VRFs 302-1 and 302-2, performing operations on the data, and writing data back to a VRF (e.g., 302-4).

ISAs define the total number of Vector Registers (VREGs) that exist within a VPU. ISAs also expect the vector lanes 206 to contain enough memory to support the defined VREGs. In the example of FIG. 3A, the ISA defines 32 VREGs. Each of the 32 VREGs has one fragment in each of the vector lanes 206 as shown in the VRFs 302-1 through 302-32 in FIG. 3A. More generally, a given vector register is distributed across multiple vector lanes. In other examples, the ISA defines a different number of VREGs that are fragmented evenly across the vector lanes 206.

Each of the vector lanes 206 includes its own pipeline circuitry 304. In the example of FIG. 3A, the pipeline circuitry 304 is composed of FPUs and ALUs. In some examples, the pipeline circuitry 304 additionally or alternatively includes different logic circuits including but not limited to Fuse-Multiply-Add (FMA) units.

Each of the vector lanes 206 also includes its own MMC 310. The MMC 310 is a comparatively small matrix multiplier circuits that, within a given vector lane (e.g. 206-1), connects only to the internal VRFs 302, the lane sequencer circuitry 208, a previous vector lane circuit (e.g., 206-8) in the ring structure, and a next vector lane circuit (e.g., 206-2) in the ring structure. In contrast, other VPUs include a larger matrix multiplier circuit that couples to all vector lanes within the VPU using comparatively long interconnects. The smaller size of the MMC 310 and shorter interconnect length of the ring structure increases performance, decreases cost, and decreases complexity of the example VPU 110 compared to known VPUs as described above. The matrix multiplier circuitry 310 is described further in connection with FIG. 3B.

FIG. 3B is a second example block diagram of an example implementation of the vector lane circuitry of FIG. 2. FIG. 3B includes the VRFs 302 (labelled VRFs 302-1 to 302-32), the pipeline circuitry 304, and the MMC 310 as shown in FIG. 3A. FIG. 3B also shows the vector lane circuitry 206-1 includes example busses 312-1 and 312-2. The bus 312-2 includes example output ports 314-1, 314-2, 314-3 (collectively output ports 314). FIG. 3B also shows the MMC 310 includes an example multiplexer (mux) 316, example matrix sequencer circuitry 318, example row buffer circuitry 320, example column buffer circuitry 322, example Multiply-And-Accumulate (MAC) circuits 324-1, 324-2, . . . , 324-64 (collectively referred to as MAC circuits 324), example accumulator memory units 326-1, 326-2, . . . , 326-64 (collectively referred to as accumulator memory 326), and an example store buffer 328.

The busses 312-1 and 312-2 both refer to one or more physical connections (e.g., an interconnect, copper trace, etc.) that enable communication between various components within the vector lane circuitry 206-1. For example, the bus 312-1 enables data generated from the pipeline circuitry 304 and/or the MMC 310 to be stored in any of the VRFs 302. The busses 312-1 and 312-2 may be implemented using one or more communication systems that meet pre-determined threshold power and latency requirements. In some examples, the busses 312-1 and 312-2 may be referred to as crossbar circuits.

The bus 312-2 enables data stored in the VRFs 302 to be accessed by the pipeline circuitry 304 and/or the MMC 310. FIG. 3B shows two example implementations of the bus 312-2. In the first example implementation, the vector lane circuitry 206-1 includes the mux 316. The mux 316 has input ports coupled to the output ports 314-3 of the bus 312-2. The mux 316 also has output ports coupled to both the pipeline circuitry 304 and the MMC 310. The mux 316 provides a given unit of data from the VRFs 302 to either the pipeline circuitry 304 or the MMC 310. The mux 316 determines the destination for the unit of VRF data based on instructions from either the pipeline circuitry 304 or the MMC 310. In this first example implementation, the bus 312-2 does not include the output ports 314-1 or the output ports 314-2 because all VRF data flows through the output ports 314-3 and the mux 316. However, in some situations, this data path may cause one of the pipeline circuitry 304 or the MMC 310 to temporarily stop operations while waiting for the mux 316 to finish providing data to the other circuit.

In the second example implementation, the bus 312-2 includes all of the output ports 314 shown in FIG. 3B. Here, the output ports 314-1 and the output ports 314-2 provide VRF data directly to the row buffer circuitry 320 and column buffer circuitry 322 within the MMC 310, respectively. Accordingly, the vector lane circuitry 206-1 does not include the mux 316 in the second example implementation, and the risk of adding latency due to data transfer is mitigated. However, the bus 312-2 may require additional space or cost in the second example (compared to the foregoing first example) to implement the additional output ports 314-1 and 314-2.

Within the MMC 310, the matrix sequencer circuitry 318 receives operation instructions from the lane sequencer circuitry 208. The matrix sequencer circuitry 318 then controls how the other components of the MMC 310 perform operations based on the operation instructions. In some examples, operations performed by the matrix sequencer circuitry 318 may be referred to as configuring the MMC 310. In some examples, the matrix sequencer circuitry 318 is instantiated by programmable circuitry executing matrix sequencer instructions and/or configured to perform operations such as those represented by the flowchart(s) of FIG. 15.

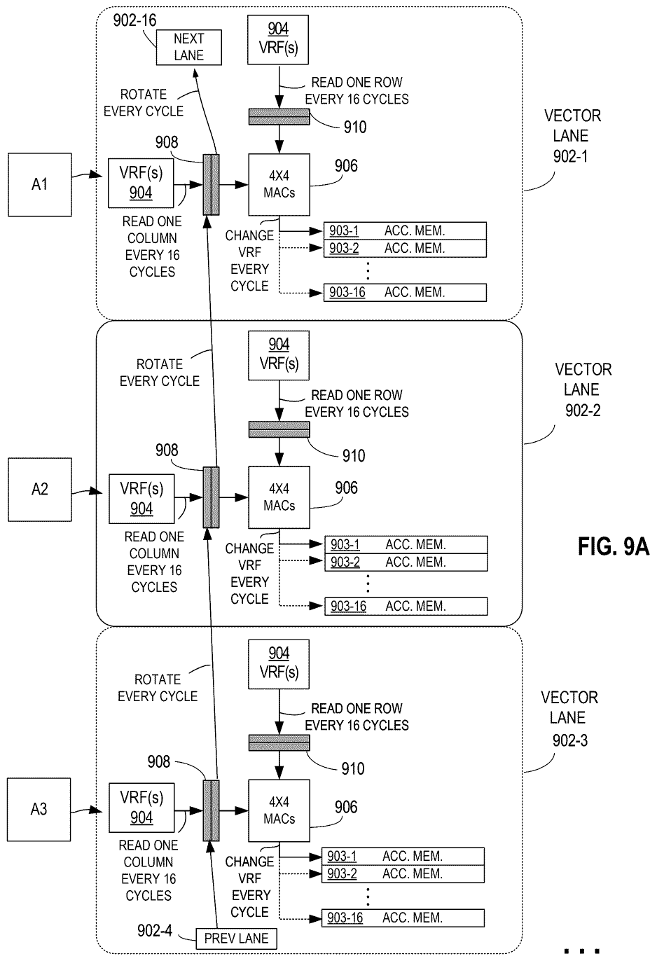

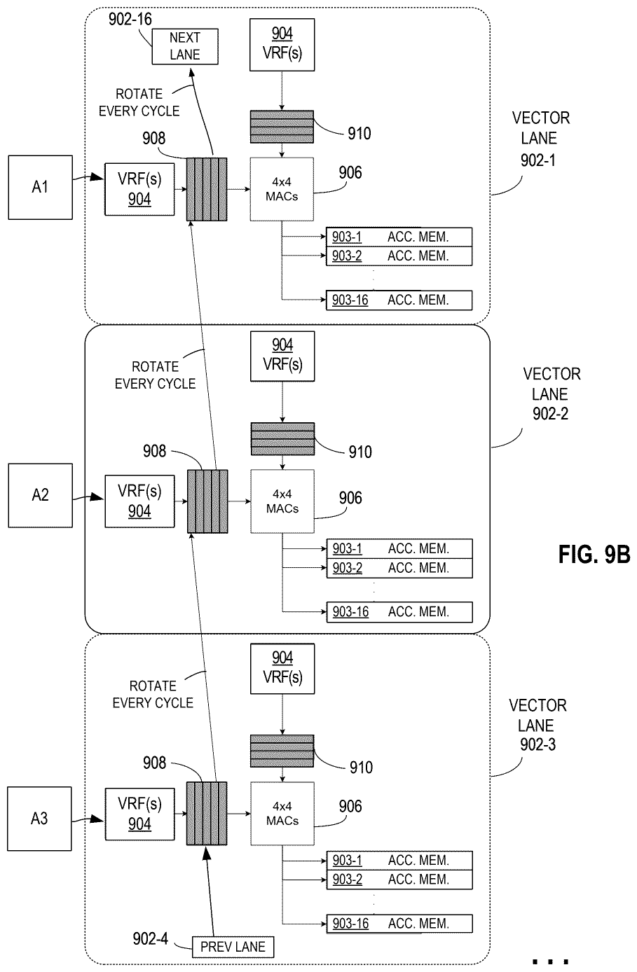

The row buffer circuitry 320 and the column buffer circuitry 322 both include memory circuits (referred to as buffers) to temporarily store input matrix data. A given column of memory within the column buffer circuitry 322 stores a portion of a column of a first input matrix. Similarly, a given row of memory within the row buffer circuitry 320 stores a portion of a row of elements from a second input matrix. In general, the row buffer circuitry 320 may include any number of memory rows and the column buffer circuitry 322 may include any number of memory columns. The memory dimensions of the row buffer circuitry 320 and the column buffer circuitry 322 are described further in connection with FIG. 9A. In the example of FIG. 3B, the row buffer circuitry 320 and column buffer circuitry 322 implement First In First Out (FIFO) queues by transferring, at any given cycle of matrix multiplication, the oldest data currently in the buffers to the MAC circuits 324.

In the example of FIG. 3B, the row buffer circuitry 320 obtains input matrix data from only the VRFs 302, while column buffer circuitry 322 may obtain input matrix data from either the VRFs 302 or the vector lane circuitry 206-8. FIG. 3B also shows the column buffer circuitry 322 can transfer input matrix data to the vector lane circuitry 206-2. Thus, in the example of FIG. 3B, the row buffer circuitry 320 obtains data only from within its respective vector lane 206-1 while the column buffer circuitry 322 can also rotate data between the vector lanes 206 using the ring structure of interconnects. In other examples, the column buffer circuitry 322 only obtain data from within its respective vector lane 206-1 while the row buffer circuitry 320 can also rotate data between the vector lanes 206 using the ring structure of interconnects. In any of the foregoing examples, both the row buffer circuitry 320 and the column buffer circuitry 322 determine what input matrix data to obtain, and where to obtain said data from, based on instructions from the matrix sequencer circuitry 318.

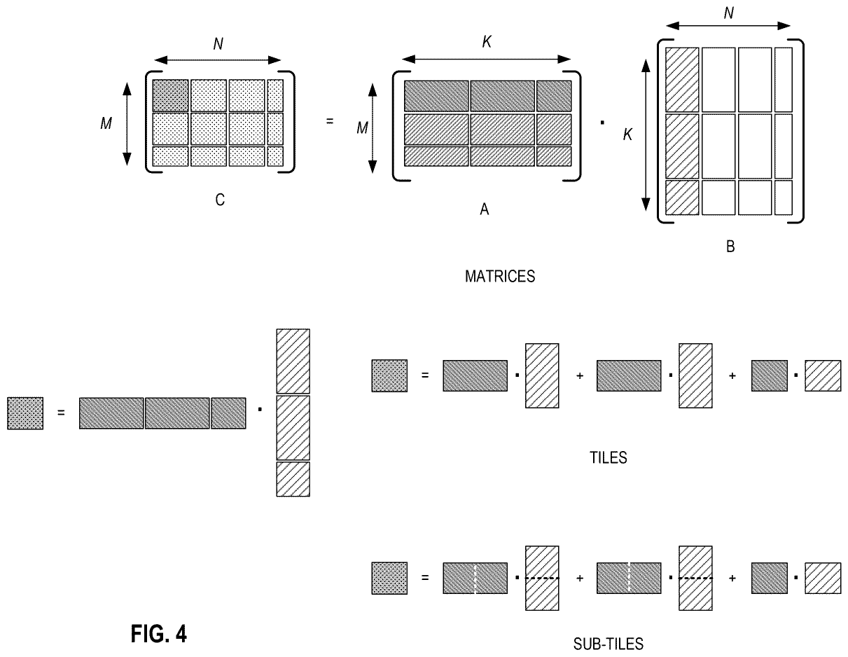

The MAC circuits 324 collectively perform matrix multiplication by multiplying elements from the row buffer circuitry 320 with elements from the column buffer circuitry 322. After a given MAC circuit 324-1 performs a multiplication operation, the MAC circuit 324-1 adds the product to a partial result that corresponds to the same MAC circuit 324-1. Accordingly, a given MAC circuit 324-1 produces (over the course of multiple cycles) an output matrix element by computing a sum of products. The mathematical operations within matrix multiplication are described further in connection with FIG. 4. In the example of FIG. 3B, a given MAC circuit 324-1 stores its partial results in its corresponding accumulator memory circuitry 326-1, and all MAC circuits 324 temporarily store their output matrix elements in the store buffer 328 until they can be transferred into the VRFs 302. In some examples, the MAC circuits 324 interface directly with the VRFs 302 to store both partial results and subsequent output matrix elements. The storage of data output by the MAC circuits 324 is described further in connection with FIG. 9A.

In some examples, a given MAC circuit performs multiplication with a first operand corresponding to data from the column buffer circuitry 322 and a second operand corresponding to different data from the row buffer circuitry 320. The data received by a particular MAC circuit from the row buffer circuitry 320 and the column buffer circuitry 322 is dependent on where the MAC circuit is physically located in the MMC 310. In the example of FIG. 3B, the 64 MAC circuits 324 are implemented in a grid that has eight rows and eight columns. Accordingly, both the row buffer circuitry 320 and the column buffer circuitry 322 each have eight sets of output terminals. More generally, the grid of MAC circuits 324 within the MMC 310 may have any dimensions so long as a) the number of output terminals of the row buffer circuitry 320 is a multiple of the number of rows in the grid and b) the number of output terminals of the column buffer circuitry 322 is a multiple of the number of columns in the grid. In some examples, the grid does not have square dimensions (that is, the number of columns and number of rows in the grid are unequal).

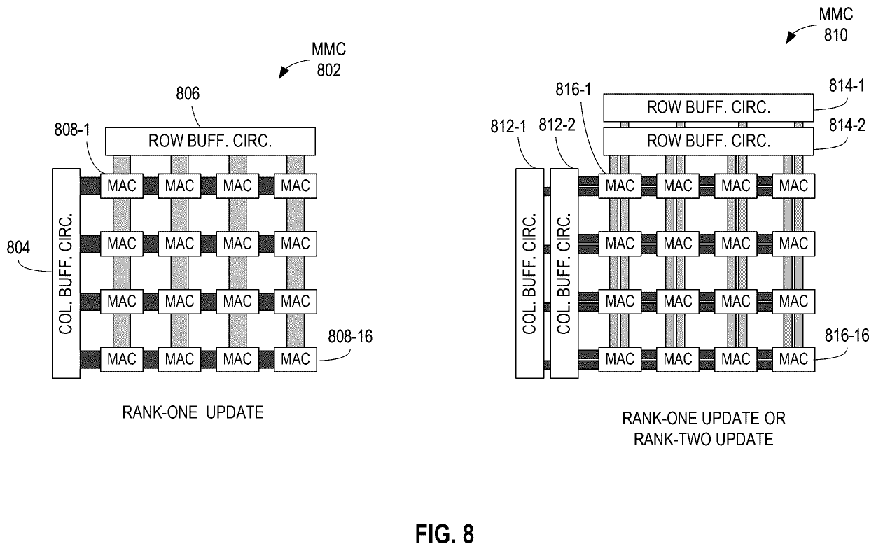

The row buffer circuitry 320 and column buffer circuitry 322 both use their output terminals to broadcast data within their memory circuits to the MAC circuits in the corresponding row or column of the grid. For example, the column buffer circuitry 322 broadcasts data from the first index of its oldest column to the MAC circuits 324-1 through 324-8 because they are physically aligned with the position of the values stored in the first index. Similarly, the column buffer circuitry 322 also broadcasts data from the second index of its oldest column to the MAC circuits 324-9 through 324-16, . . . , and broadcasts data from its eighth index of its oldest column to the MAC circuits 324-57 through 324-64 during the first cycle. At the same time, the row buffer circuitry 320 broadcasts data from the first index of its oldest row to the MAC circuits 324-1, 324-9, 324-17, 324-25, 324-33, 324-41, 324-49, 324-57 because they are physically aligned with the position of the values stored in the first index, . . . , and broadcasts data from the eighth index of its oldest row to the MAC circuits 324-8, 324-16, 324-32, 324-40, 324-48, 324-56, 324-64. Thus, the operands obtained by a particular MAC circuit correspond to its row and column index within the grid. For example, the MAC circuit 324-27 multiplies a) data received from the fourth index of the oldest column in the column buffer circuitry 322 with b) data received from the third index of the oldest row in the row buffer circuitry 323. The type of operands received by the MAC circuits 324 are described further in connection with FIG. 8.

FIG. 4 is an illustrative example of matrices, tiles, and sub-tiles. The example of FIG. 4 includes an A matrix, a B matrix, and a C matrix. As used herein, the A matrix is also referred to as a first input matrix, and the B matrix is also referred to a second input matrix. The A and B matrices are defined by one or more user space programs such as the software applications of FIG. 1. In some examples, a user space program also requests the VPU 110 multiply the A and B matrices together. The user space programs may populate the A and B matrices with any type of data. For example, the A matrix stores activation values, and the B matrix stores weight values in many machine learning contexts. A user space program also instructs the VPU 110 to multiply the A matrix to the B matrix. As used herein, the C matrix is also referred to as an output matrix formed by the multiplication of the A matrix and the B matrix. In FIG. 4, the A matrix has M rows and K columns, while the B matrix has K rows and N columns. Accordingly, the resultant C matrix has M rows and N columns.

Many user space programs utilize the multiplication of extremely large matrices. As a result, one or more of the matrix dimensions of FIG. 4 (e.g., the values K, N, and M) can correspond to a value in the hundreds or thousands. Such matrices may be too large to be computed in a single matrix multiplication cycle, even when the operations are distributed across multiple MMCs 310 in the multiple vector lanes 206. As used above and herein, a matrix multiplication cycle refers to the amount of time required for one MAC circuit to produce one partial result (e.g., one product in the sum of products that define an element in the C matrix as described further below). A single matrix multiplication cycle may therefore refer to one or more clock cycles.

To deal with such large matrix sizes, the VPU 110 subdivides the A matrix, B matrix, and the C matrix into tiles, and subdivides the tiles further into sub-tiles. As used above and herein, a tile refers to a portion (e.g., a submatrix, a chunk of data, etc.) of an A matrix, a B matrix, or a C matrix. In some examples, tiles have characteristics that enable them to fit within a corresponding matrix in the sense that multiple tiles can be arranged in a particular, non-overlapping manner to collectively form a matrix whose dimensions are larger than any individual tile. For instance, the A matrix includes nine tiles, the B matrix includes twelve tiles, and the C matrix includes twelve tiles in the example of FIG. 4. Other characteristics of tiles may include but are not limited to: two tiles within the same matrix do not overlap with one another, a tile can have horizontal and vertical dimensions, a tile can have an index or position within its corresponding matrix. In some examples, tiles do not exhibit one or more of the foregoing characteristics.

Advantageously, tiles can have different sizes, and the examples described herein enable the VPU 110 using different techniques to perform matrix multiplication based on the various tile sizes. In some examples, the size of a tile may also be referred to as the dimensions of the tile and/or the number of elements in the tile. As used herein, an A tile refers to a tile from an A matrix, a B tile refers to a tile from a B matrix, and a C tile refers to a tile from a C matrix.

In view of the foregoing, the terms “input tile” and “input tiles” as used herein may refer one or more A tiles and/or B tiles. Similarly, the terms “output tile” and “output tiles” may refer to one or more C tiles. In some examples, the process of multiplying two input tiles is referred to as populating an output tile. Similarly, an output matrix (e.g. a C matrix) may be populated by combining one or more populated output tiles.

A, B, and C matrices are divided into tiles such that a given C tile is computed by multiplying a row of A tiles to a column of B tiles, where the number of A tiles in the row is equal to the number of B tiles in the column. The computation of the C tile can therefore be decomposed into a sum of products where the first product is generated by multiplying the first A tile in the row with the first B tile is the column, . . . , and the last product is generated by the last A tile in the row with the last B tile in the column. To support such tile multiplication, the number of columns of A tiles (e.g., three in FIG. 4) is equal to the number of rows of B tiles (e.g., three in FIG. 4) for matched row-column tiles.

In many examples, the size of the A, B, and C matrices are so large that a single C tile is still unable to be computed in a single matrix multiplication cycle, even when the operations are distributed across multiple vector lanes 206. Accordingly, tiles are further divided into sub-tiles. As used herein, an A sub-tile refers to a portion (a submatrix) of an A tile and a B sub-tile refers to a portion a B tile. A C sub-tile refers to a product that, when added with other products, creates a portion of a C tile. Thus, a C sub-tile is computed by multiplying an A sub-tile and a B sub-tile. Moreover, a C sub-tile is a partial result that, when added to multiple other C sub-tiles at the same index, forms a portion of a final C tile.

There is an upper limit to the amount of data that can be stored within a single sub-tile instance of the vector lane circuitry 206-1 (e.g., sub-tiles have a maximum size). This enables the VPU 110 to create sub-tiles such that a single instance of the vector lane circuitry 206-1 multiplies one A sub-tile and one B sub-tile to produce one C sub-tile over the course of one matrix multiplication cycle. Accordingly, sub-tiles refer to a sufficiently small amount of data so that the VRFs 302 within a single instance of the vector lane circuitry 206-1 can simultaneously store at least one A sub-tile and at least one B sub-tile.

While the dimensions of the input A and B matrices are determined by user space programs such as the software applications 102, the subsequent A, B, and C tile dimensions and sub-tile dimensions may be determined by either a user space program or by the VPU 110. Techniques for a source to determine tile dimensions and sub-tile dimensions are described further in connection with FIG. 15.

In general, the term “matrix” refers to an A matrix, B matrix, or C matrix as described in FIG. 4 unless the term is given a different meaning in context. Similarly, the term “tile” generally refers to a portion of a matrix and the term “sub-tile” generally refers to a portion of a tile unless the terms are given different meanings in context. Thus, FIG. 4 and the examples described herein implement a data organization hierarchy in which a matrix is divisible into multiple tiles and a tile is divisible into multiple sub-tiles. Here, the term “divisible” means that the sub-tiles are dimensionally smaller than the tiles and the tiles are dimensionally smaller than the matrix. A given sub-tile may be dimensionally smaller by having fewer rows, fewer columns, or both in comparison to its corresponding tile. Similarly, a given tile may be dimensionally smaller by having fewer rows, fewer columns, or both in comparison to its corresponding matrix.

In general, an operand refers to a quantity with which operations are performed. Thus, the term “operand” as used above and herein may refer to one or more elements within a sub-tile, an entire sub-tile, an entire tile, or an entire matrix depending on the context of the operations being performed.

FIGS. 5A-5F are a first illustrative example of matrix multiplication operations performed by the VPU of FIG. 2. FIG. 5A shows an example A matrix 502 that includes example A tiles 504-1, 504-2, . . . 504-12 (collectively referred to as A tiles 504). FIG. 5A also shows an example B matrix 506 that includes example B tiles 508-1, 508-2, . . . 508-12 (collectively referred to as B tiles 506) and an example C matrix 510 that includes an example C tile 512.

The A matrix 502, the B matrix 506, and the C matrix 510 are divided into tiles in a manner that supports matrix multiplication as described above in FIG. 4. For example, the computation of the C tile 512 can be expressed using equation (1):

$$C {tile}_{512} = {\sum }_{i = 1}^{12} ( A {tile}_{504 - i} \cdot B {tile}_{508 - i} ) \qquad ( 1 )$$

In this example, the VPU 110 computes the twelve products (which each describe the multiplication of an A tile 504 to a B tile 508) sequentially. Thus, the VPU 110 gradually builds towards a final value of C tile₅₁₂ by repeatedly a) computing an ith product (A tile₅₀₄₋ᵢ·B tile₅₀₈₋ᵢ) and b) adding the ith product to a partial result that is itself a sum of the previous (i-1) products. The example of FIG. 5A describes this partial result using equation (2):

$$C {tile}_{512 - i} = C {tile}_{512 - ( i - 1 )} + ( A {tile}_{504 - i} \cdot B {tile}_{508 - i} ) \qquad ( 2 )$$

In equation (2), C tile₅₁₂₋ᵢ is the partial result at the end of i iterations of the summation of equation (1). Similarly, C tile₅₁₂₋₍ᵢ₋₁₎ is the partial result at the end of the previous iteration of the summation (e.g., the iteration with index (i-1)).

FIG. 5B shows how an example VPU described herein implements equation (2). In the example of FIGS. 5A-5F, a source coordinates the operation of the VPU 110 such that vector lanes 206-1 through 206-4 work together to multiply one of the A tiles 504 to one of the B tiles 508 at a time. During such tile multiplication, the vector lanes 206-5 through 206-8 may be used to multiply different ones of the A tiles 504 and B tiles 508 or may be reserved for operations that correspond to a different user space program.

A source defines sub-tiles dimensions in FIGS. 5A-5F such that the number of sub-tiles in a given A tile 504-i or given B tile 508-i is a multiple of four. In particular, a given A tile 504-i in the example of FIGS. 5A-5F is composed of four sub-tiles labeled A1, A2, A3, and A4. Similarly, a given B tile 508-i in the example of FIGS. FA-5F is composed of four sub-tiles labeled B1, B2, B3, and B4.

A source defines sub-tile dimensions as described above because there are four vector lanes (206-1 through 206-4) assigned to the corresponding matrix multiplication. More generally, a source (e.g., a VPU or a user space program) described herein defines sub-tile dimensions with the goal of having the number of sub-tiles per tile be evenly divisible by the number of vector lanes assigned to the matrix multiplication. For example, as set out in more detail below with reference to FIG. 15, the VPU may provide recommendations in terms of tile dimensions while the user space program may select tile dimensions and determine a corresponding matrix multiplication technique based on the selection. If the number of sub-tiles per tile is evenly divisible by the number of vector lanes assigned to the matrix multiplication (as shown in FIGS. 5B-5F), then the VPU 110 avoids a scenario where some of the vector lanes need to idle (because they do not have any A or B sub-tile data remaining for the current C tile) while waiting for a different vector lane (that still has A and B sub-tile data remaining) to finish performing the operations necessary to compute a C tile. Accordingly, a source implemented according to the examples herein can determine sub-tile dimensions in a manner that increases computational efficiency.

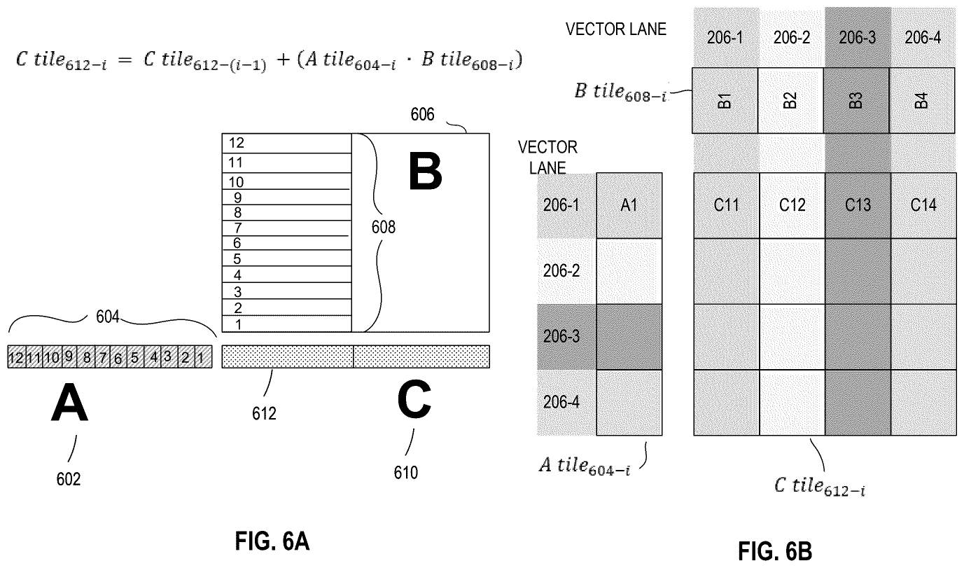

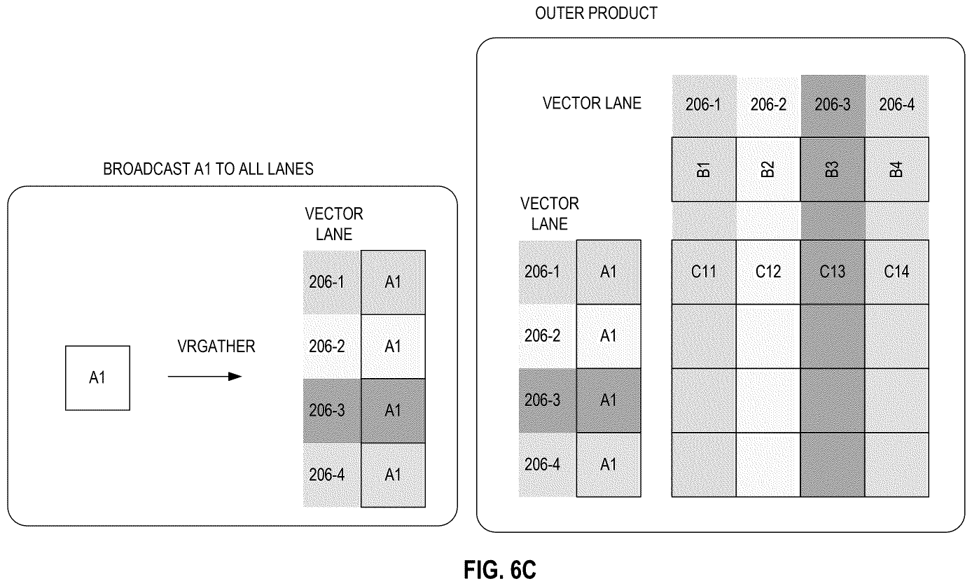

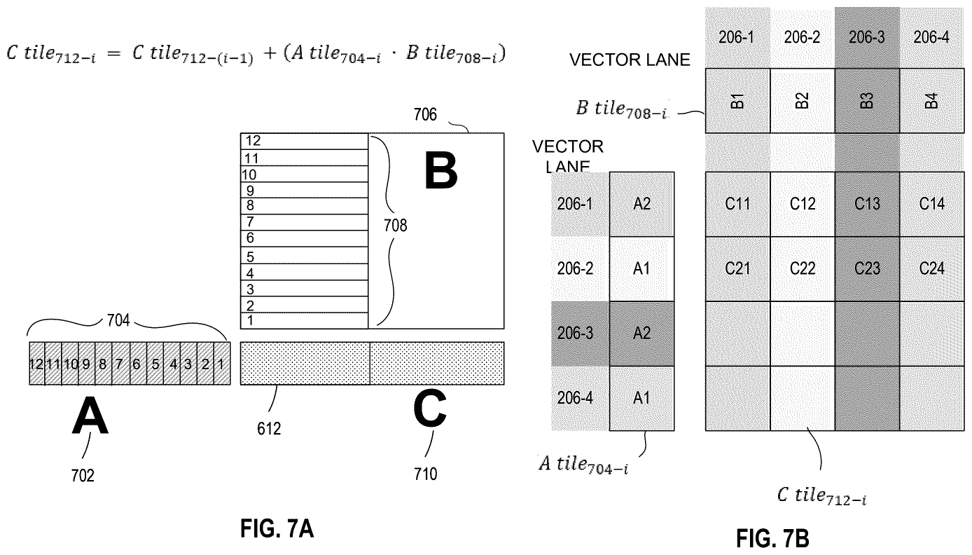

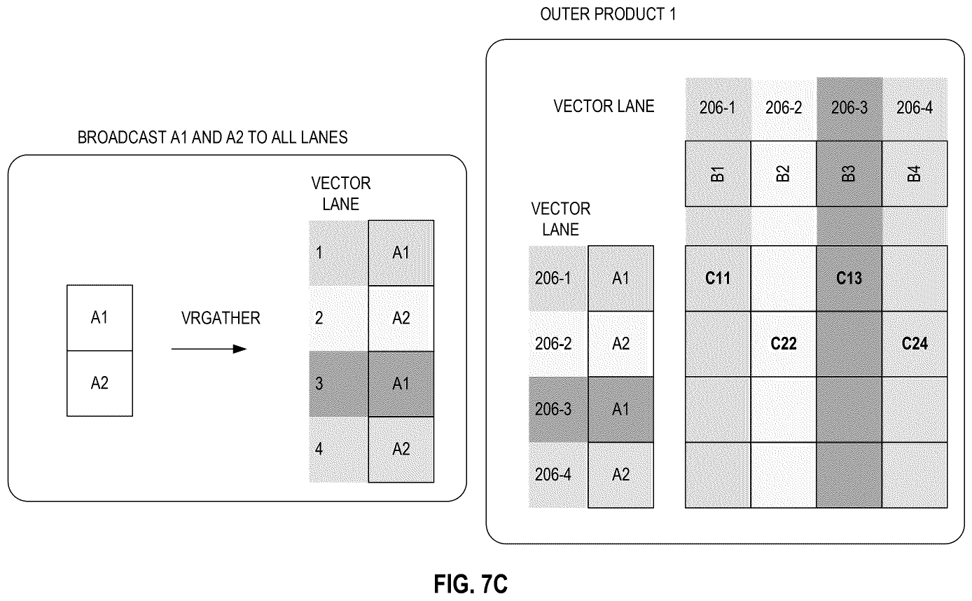

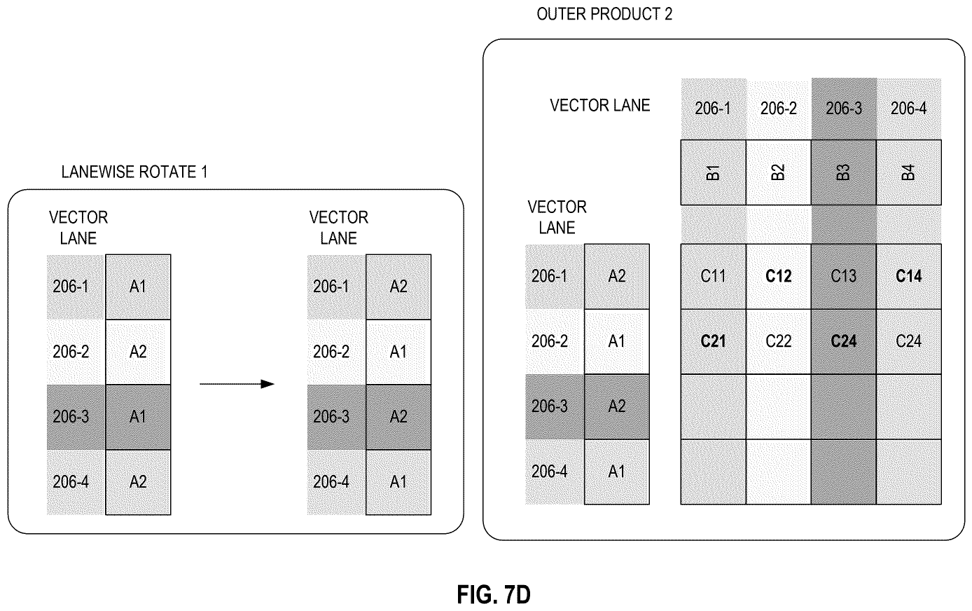

Sub-tile dimensions are dependent on tile dimensions, which in turn are dependent on matrix dimensions. Matrix dimensions are set by user space programs and are not controllable by the VPU 110. Accordingly, in some examples, the VPU 110 is unable to set the number of sub-tiles per tile to a value that is evenly divisible by the number of vector lanes. Similarly, some user space programs may be unable to set the number of sub-tiles per tile to a value that is evenly divisible by the number of vector lanes because the portion of the user space program that populates input matrices is independent from the portion of the user space program that defines tile and sub-tile dimensions. More generally, the dimensions of an input matrix are highly specific to the context of a given use case and are generally difficult to adjust for VPU efficiency considerations. Advantageously, a source described herein maintains high computational efficiency (and more generally, high performance) in such examples by can adjusting how the vector lanes 206 perform matrix multiplication in view of the input matrix dimensions. Examples where the number of sub-tiles per tile is not evenly divisible by the number of vector lanes are described further in connection with FIGS. 6A-6C and 7A-7D.

FIG. 5B shows one example of how the VPU 110 multiplies an A tile 504-i to a B tile 508-i to produce the partial result C tile 512-i. To Before execution of the partial result begins, the vector lane circuitry 206-1 loads some or all of the A1 sub-tile data into its column buffer circuitry 322 and some or all of the B1 sub-tile data into its row buffer circuitry 320. Similarly, the vector lane circuitry 206-2 loads some or all of the A2 sub-tile data into its column buffer circuitry 322 and some or all of the B2 sub-tile data into its row buffer circuitry 320, . . . , and the vector lane circuitry 206-4 loads some or all of the A4 sub-tile data into its column buffer circuitry 322 and some or all of the B4 sub-tile data into its row buffer circuitry 320, before execution of the sub-result begins. Thus, the vector lanes 206-1 through 206-4 receive different portions of input matrix data (e.g., A1, A2, A3, A4) at FIG. 5B. More generally, in examples described above and herein, input data loaded into column buffer circuits 322 only comes from A matrices and input data loaded into row buffer circuits 320 only comes from B matrices. In other examples, input matrix data is described with different nomenclature.

In the example of FIGS. 5A-5F, the different portions of input matrix data (e.g., the sub-tiles) have the characteristic of not overlapping with one another. That is, in FIGS. 5A-5F, each element within the A matrix 502 is uniquely assigned to one A sub-tile and there are no elements within the A matrix 502 (or within the A tiles 504) that are assigned to two or more A sub-tiles. In other examples, different portions of input matrix data (e.g., units within different data organization hierarchies) have the characteristic of overlapping with one another.

The partial result C tile 512-i is a matrix that is decomposed into sub-tiles C11 through C44. The sub-tiles are arranged in FIG. 5 such that a given sub-tile refers to the product of an A sub-tile at its corresponding row and a B sub-tile at its corresponding column. Thus, C11=A1·B1, C12=A1·B2, C13=A1·B1, . . . , and C44=A4·B4.

FIG. 5B shows there are sixteen sub-tiles within the partial result C tile 512-i. As described above, a given vector lane circuit 206-1 multiplies one A sub-tile and one B sub-tile to produce one C sub-tile over the course of one matrix multiplication cycle. Thus, the VPU 110 can compute the partial result C tile 512-i over four matrix multiplication cycles by having each of the four vector lanes generate a new C sub-tile during each matrix multiplication cycle. FIG. 5C shows that the VPU 110 begins matrix multiplication operations using the sub-tile data distribution described above. Thus, by the end of the first matrix multiplication cycle, the vector lane circuitry 206-1 has performed A1·B1=C11, the vector lane circuitry 206-2 has performed A2·B2=C22, the vector lane circuitry 206-2 has performed A3·B3=C33, and the vector lane circuitry 206-4 has performed A4·B4=C44. These operations are collectively referred to as a first outer product in FIG. 5C.

After a given matrix multiplication cycle ends, the MMCs 310 in the vector lanes 206 require new operands (new A sub-tiles or B sub-tiles) to generate new results (e.g., new C sub-tiles). In this example, the vector lanes 206 rotate A sub-tile data through a ring structure of interconnects while keeping B sub-tile data stationary as described above in connection with FIG. 3B. Thus, FIG. 5C shows the vector lanes 206 use the ring structure to transfer A1 to the vector lane circuitry 206-4, A4 to the vector lane circuitry 206-3, A3 to the vector lane circuitry 206-2, and A2 to the vector lane circuitry 206-1. Such operations are collectively referred to as a first lane wise rotation in FIG. 5C.

Advantageously, VPUs described herein perform outer products and lane wise rotations in parallel with one another during a matrix multiplication cycle. For example, suppose each of the A sub-tiles (which are matrices) is composed of n vectors that can be stored across n columns of memory within the column buffer circuitry 322. As used above and herein, a vector of data refers to either a) a column of data within an A sub-tile or b) a row of data within a B sub-tile. After the column buffer circuitry 322 in the vector lane circuitry 206-1 transmits the first A1 vector to the MAC circuits 324 and the MAC circuits 324 perform the corresponding multiplication operations, all portions of the C11 sub-tile computation that rely on the first A1 vector as an operand are complete. Thus, the vector lane circuitry 206-1 is free to transfer the first A1 vector to the vector lane circuitry 206-2 (which is the next vector lane in the sequence). The transfer opens space in the memory of the column buffer circuitry 322 to receive and store the first A2 vector from the vector lane circuitry 206-2. While the column buffer circuitry 322 is transmitting the first A1 vector and receiving the first A2 vector, the MAC circuits 324 are independently performing operations with the second A1 vector. The MMC 310 within the vector lane circuitry 206-1 repeats the parallel operations of a) transmitting a first A1 vector, b) receiving an A2 vector, and c) performing multiplication with a second A1 vector n times. After the nth iteration, the first matrix multiplication cycle ends and the vector lane circuitry 206-1 has completed the computation of C11. Moreover, the vector lane circuitry 206-1 can immediately begin work on A2·B1=C21 (as shown in FIG. 5D) after the nth iteration because A2 data is already present in the column buffer circuitry 322.

The foregoing example causes less latency (and is therefore more efficient) than a scenario where the vector lanes first complete an outer product computation and then perform lane wise rotations by transferring all of the A sub-tile data at once. More generally, VPUs described herein can use the parallel implementation of outer product computations and lane wise rotations as a technique to maintain a high level of arithmetic intensity. As used above and herein, arithmetic intensity refers to a ratio of computational operations to the data transfer exhibited by a VPU. In general, increasing arithmetic intensity means the VPU 110 is performing more efficiently by performing a larger number of computational operations (e.g., more matrix multiplication) per unit of data transfer. In some examples, arithmetic intensity is referred to as compute intensity.

FIG. 5D shows the second matrix multiplication cycle of the partial result C tile 512-i. During the second matrix multiplication cycle, the vector lanes 206 collectively perform second outer product operations (which generate sub-tiles C21 C32, C43, and C14) and a second perform lane wise rotation in parallel. Similarly, FIG. 5E shows the third matrix multiplication cycle which includes third outer product operations and third lane wise rotations in parallel with one another. Finally, the partial result C tile 512-i is completed after the fourth outer product operations of FIG. 5F. The fourth matrix multiplication cycle does not include a lane wise rotation because each of the vector lanes 206 has received each of the A sub-tiles necessary to compute the partial result C tile 512-i. Rather, the fourth matrix multiplication cycle may be spent transferring one or more portions of data from the (i+1)th A tile 504 and the (i+1)th B tile 508 from the VRFs 302 into the respective column buffer circuits 322 and row buffer circuits 320. Because one iteration of the operations from FIGS. 5B-5F generates a partial result corresponding to one dot product as shown in equation (1), the VPU 110 iterates through the operations of FIGS. 5B-5F twelve times and adds the subsequent products together to determine the final value of the C tile 512.

FIGS. 6A-6C are a second illustrative example of matrix multiplication operations performed by the VPU 110. FIG. 6A shows an example A matrix 602 that includes example A tiles 604-1, 604-2, . . . 604-12 (collectively referred to as A tiles 604). FIG. 6A also shows an example B matrix 606 that includes example B tiles 608-1, 608-2, . . . 608-12 (collectively referred to as B tiles 608) and an example C matrix 610 that includes an example C tile 612.

Like the example of FIGS. 5A-5F, four of the vector lanes 206 within the VPU 110 are used to multiply one of the A tiles 604 to one of the B tiles 608 at a time. A source assigns four vector lanes to the foregoing tile multiplication because the B matrix 606 is comparatively large. However, the A matrix 602 is comparatively small in the example of FIG. 6. As a result, each of the A tiles 604 has only one sub-tile (labelled A1 in FIG. 6B). Thus, the number of sub-tiles per A tile (one) is not evenly divisible by the number of vector lanes assigned to the matrix multiplication (four).

FIG. 6B shows a given partial result C tile 612-i is composed of four sub-tiles (labelled C1, C12, C13, and C14). Notably, the computation of each C sub-tile is dependent on the use of A1 as an operand. Thus, if the A1 data is transferred from the memory 108 to just one vector lane circuitry 206-1 to begin and then rotated amongst the lanes using the ring structure of interconnects as described above, the computation of a given partial result C tile 612-i would require four matrix multiplication cycles. However, such an approach has comparatively low arithmetic intensity (and more generally, has a comparatively low computational efficiency) because three of the four vector lanes 206-1 through 206-4 must idle during any given matrix multiplication cycle while waiting to receive the A1 data.

Advantageously, the examples described herein enable a VPU to adjust matrix multiplication techniques based on input matrix dimensions and VPU hardware dimensions. FIG. 6C shows that rather than using lane wise rotations in this example, the VPU 110 broadcasts (e.g., provides, makes copies of and transfers, etc.) the A1 data to each of the vector lanes 206-1 through 206-4. Thus, the vector lanes 206-1 through 206-4 receive the same portion of input matrix data (e.g., A1) at FIG. 6C. In this configuration, each vector lane's matrix multiplier circuitry then uses this common first operand in a multiplication with a second operand corresponding to its respective unique B-sub-tile data (e.g., B1, B2, B3, and B4). In the reduced instruction set computer (RISC)-V ISA, an operation instruction 212 with the operation code ‘vrgather’ is used to instruct the VPU 110 to perform a broadcast. In other examples, a different type of instruction is used to instruct the VPU 110 to perform a broadcast. Thus, the vector lanes 206-1 through 206-4 can use the A1 data in parallel with one another to complete the partial result C tile 612-i in a single matrix multiplication cycle.

FIGS. 7A-7D are a third illustrative example of matrix multiplication operations performed by the VPU 110. FIG. 7A shows an example A matrix 702 that includes example A tiles 704-1, 704-2, . . . 704-12 (collectively referred to as A tiles 704). FIG. 7A also shows an example B matrix 706 that includes example B tiles 708-1, 708-2, . . . 708-12 (collectively referred to as B tiles 708) and an example C matrix 710 that includes an example C tile 712.

Like the example of FIGS. 5A-5F and 6A-6C, four of the vector lanes 206 within the VPU 110 are used to multiply one of the A tiles 704 to one of the B tiles 708 at a time. A source assigns four vector lanes to the foregoing tile multiplication because the B matrix 606 is comparatively. FIGS. 7A and 7B show the relative size of the A matrix 702 and B matrix 706 leads a source to divide each of the A tiles 704 into two sub-tiles (labelled A1 and A2) and each of the B tiles 708 into four sub-tiles (labelled B1, B2, B3, and B4). Thus, the example of FIGS. 7A-7D represents a middle ground between the foregoing examples in that using lane wise rotations to multiply an A tile 704-i with a B tile 708-i would be more computationally efficient than using lane wise rotations to multiply an A tile 604-i with a B tile 608-i but still less efficient than using lane wise rotations to multiply an A tile 504-i with a B tile 508-i.

Advantageously, a source described herein can scale lane wise rotations operations and sub-tile broadcast operations performed by a VPU up or down based on a relative difference in input matrix dimensions. For example, FIG. 7C shows that in response to one or more ‘vrgather’ instructions, the VPU 110 broadcasts A1 data to the vector lanes 206-1 and 206-3 and broadcasts A2 data to the vector lanes 206-2 and 206-4. Thus, the four vector lanes simultaneously operate on two different A sub-tiles in a given matrix multiplication cycle.

By the end of the first matrix multiplication cycle, the vector lanes 206-1 through 206-4 performed first outer product operations that generate C11, C22, C13, and C24 sub-tiles. These vector lanes require new operand data to determine the remaining C sub-tiles within the partial result C tile 712-i. Accordingly, FIG. 7D shows the vector lanes 206-1 through 206-4 also perform a lane wise rotation during the first matrix multiplication cycle. The lane wise rotation moves A2 data to the vector lanes 206-1 and 206-3 while and moves A1 data to the vector lanes 206-4. The partial result C tile 712-i is then completed after the second outer product operations of FIG. 7D.

The example of FIGS. 7A-7D show that in some examples, a source may instruct the VPU 110 to perform both a broadcast operation and a lane wise rotation for the same tile multiplication. As used herein, an execution plan refers to a series of instructions that describe how an example VPU performs matrix multiplication operations. Execution plans may provide a VPU described herein with information including but not limited to matrix, tile, and sub-tile dimensions, which vector lanes are assigned to perform matrix multiplication collectively, how input matrix data is distributed across the assigned vector lanes, when to perform broadcast and/or lane wise rotation operations, how to perform broadcast operations (e.g., which data is being broadcasted and where is it being sent) and/or how to perform lane wise rotation operations (e.g., which assigned vector lane is considered ‘next’ in the ring structure of interconnects).

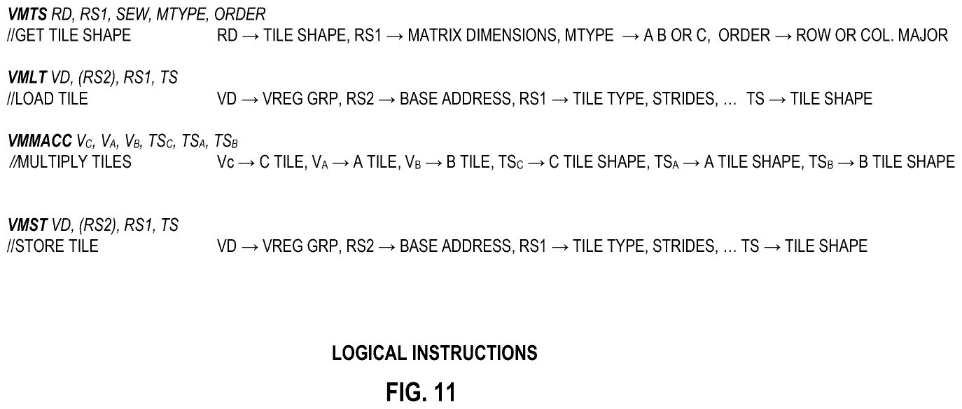

Advantageously, the VPU 110 can implement different execution plans to support different use cases. For instance, the three foregoing matrix multiplication examples (FIGS. 5A-5F, 6A-6C, and 7A-7D) correspond to three different execution plans. Furthermore, the tiles within a given input matrix may be nonuniform in size as shown in FIG. 4. Accordingly, in some examples, the VPU 110 uses a first group of the vector lanes (e.g., 206-1 through 206-4) to multiply tiles of a first size according to a first execution plan and simultaneously use a second group of the vector lanes (e.g., 206-5 through 206-8) to multiply tiles of a second, different size according to a second execution plan. More generally, VPUs described herein can support a wide variety of matrix input dimensions while still achieving high computational efficiency (e.g., high arithmetic intensity, low latency, etc.) by implementing execution plans that are designed based on specific input matrix dimensions and specific VPU hardware dimensions. Execution plans are described further in connection with FIG. 11-15.

FIG. 8 are first and second example implementations of matrix multiplier circuitry (MMC). In FIG. 8, the example MMC 802 includes example column buffer circuitry 804-1, example row buffer circuitry 806-1, and example MAC circuits 808-1, 808-2, . . . , 808-16 (collectively referred to as MAC circuits 808). The example MMC 810 of FIG. 8 includes example column buffer circuits 812-1 and 812-2, example row buffer circuits 814-1 and 814-2, and example MAC circuits 816-1, 816-2, . . . , 816-16 (collectively referred to as MAC circuits 816).

The MMC 802 and MMC 810 are both example implementations of matrix multiplier circuitry described herein. Thus, a given vector lane circuit may implement one but not both MMCs 802 and 810. When implemented in two separate vector lanes, both of the MMCs 802 and 810 receive input matrix data from VRFs within their respective vector lane and perform matrix multiplication based on an execution plan as described above.

Like the MMC 310 of FIG. 3, the MMC 802 includes one instance of column buffer circuitry 804 and one instance of row buffer circuitry 806. Thus, a given MAC circuit (e.g., 808-1) in the MMC 802 receives one element that corresponds to an A matrix and one element that corresponds to a B matrix based on its position within the grid of MAC circuits 808. The given MAC circuit then multiplies the two elements together to produce a partial result that also has a size of one element.

MMCs with one instance of column buffer circuitry and one instance of row buffer circuitry support rank-one updates. For example, suppose the MMC 802 is used to multiply a [4×4]A matrix (e.g., 4 rows and 4 columns) with a [4×4]B matrix. The MMC 802 computes the resultant [4×4]C matrix by performing four rank-one updates across four matrix multiplication cycles. In this example, a given rank-one occurs when the MAC circuits 808 multiply a given column of A data with corresponding rows of B data and then adds the resultant partial result (which is a [4×4] matrix) to the sum of the previous partial results. As used above and herein, a rank-x update refers to the addition of a partial result (e.g., a portion of a C matrix) with a rank-x matrix, where x is any positive integer.

In contrast to the MMCs 310 and 802, the MMC 810 includes two instance of column buffer circuitry 812 and two instance of row buffer circuitry 814. Thus, within a matrix multiplication cycle, a given MAC circuit (e.g., 816-1) in the MMC 810 receives A matrix data from both column buffer circuits 812 and B matrix data from both row buffer circuits 814 based on its position within the grid of MAC circuits 816.

The MMC 810 requires additional communication channels and additional input ports on the MAC (relative to the MMC 802) to support multiple column buffer circuits and row buffer circuits. However, the additional hardware resources provide the MMC 810 with flexibility to perform either rank-one or rank-two updates. As a first example, suppose a given communication channel from a row or column buffer circuit to a MAC circuit is 32 bits wide, but a user space program requests multiplication of A and B matrices that are populated with 64-bit data elements. In such an example, the MMC 810 uses the row buffer circuits 814-1 and 814-2 in a coordinated manner to provide a given MAC circuit 816-1 with a single data element from the B matrix per matrix multiplication cycle. Similarly, the MMC 810 uses the column buffer circuits 812-1 and 812-2 in a coordinated manner to provide a given MAC circuit 816-1 with one data element from the A matrix per matrix multiplication cycle. Such operations support a rank-one update as described above.

As a second example, suppose a given communication channel from a row or column buffer circuit to a MAC circuit is 32 bits wide, and a user space program requests multiplication of A and B matrices that are also populated with 32-bit data elements. In such an example, the row buffer circuits 814-1 and 814-2 provide a given MAC circuit 816-1 with two data elements from the B matrix per multiplication cycle and the column buffer circuits 812-1 and 812-2 provide a given MAC circuit 816-1 with two separate data elements from the A matrix per multiplication cycle. Accordingly, the resultant product produced by a given MAC circuit 816-1 is a rank-two matrix. More generally, FIG. 8 how the hardware architecture of an MMC can be expanded in a manner that adds cost and space in exchange for greater flexibility and wider support for various matrix multiplication use cases.

FIG. 9A is a first example implementation of the column buffer circuitry and row buffer circuitry of FIG. 3B. FIG. 9A shows example vector lanes 902-1, 902-2, and 902-3. A given vector lane circuit in FIG. 9A includes example Accumulator Memory Units 903-1, 903-2, . . . , 903-16 (collectively referred to as Accumulator Memory Units 903), a 4×4 grid of example MAC circuits 906, example column buffer circuitry 908, and example row buffer circuitry 910.

The vector lanes 902-1, 902-2, and 902-3 are three of sixteen total vector lanes (collectively referred to as vector lanes 902) assigned to perform matrix multiplication together within the example VPU of FIG. 9A. In this example, a source implements a data organizational hierarchy in which there are sixteen A sub-tiles within a single A tile. Accordingly, the VPU of FIG. 9A multiplies an A tile to a B tile by performing lane wise rotation as shown in FIGS. 5A-5F. In other examples, the VPU of FIG. 9A has different characteristics (e.g., different matrix, tile, and/or sub-tile dimensions).

In some examples, the column buffer circuit(s) within an MMC include a sufficient amount of memory to transmit all columns of a given A sub-tile to the MAC circuits before transmitting any columns of the subsequent A sub-tile. For example, in the first lane wise rotation of FIG. 5C, the vector lane circuitry 206-1 receives A2 vectors and performs matrix multiplication with A1 vectors simultaneously. The A2 vectors are stored at the end of a queue in the column buffer circuitry 322 such that the vector lane circuitry 206-1 transmits every column of A1 to the MAC circuits 324 before beginning to transmit A2 data. More generally, in some examples, vector lanes perform multiplication with all vectors within their original A sub-tile before performing multiplication with a vector from a different A sub-tile.

In contrast, the vector lanes 902 in the example of FIG. 9A have column buffer circuitry 908 with only two columns of memory. One column of memory is used to transmit data to the MAC circuits 906 while the other column of memory receives data to be transmitted in the next cycle. In general, the data received by the column buffer circuitry 908 may correspond to the original A sub-tile that is assigned to the vector lane at the start of a tile multiplication or to a different A sub-tile which is received from the previous vector lane during a lane wise rotate operation.

The vector lanes 902 support column buffer circuits with limited memory resources by performing multiplication with one vector from each of the different A sub-tiles before performing multiplication with a subsequent vector from the original A sub-tile. For example, suppose each of the A sub-tiles and the B-tiles is a [4×4] matrix so there are 4 vectors per sub-tile. Suppose further that the original A sub-tile for the vector lane circuitry 902-1 is A1, the original A sub-tile for the vector lane circuitry 902-2 is A2, and the original A sub-tile for the vector lane circuitry 902-3 is A3 as shown in FIG. 9A. In the first matrix multiplication cycle of a tile multiplication, the vector lane circuitry 902-1 multiplies a first vector of A1 (which was stored in one or more of the VRFs 904 and transferred to the column buffer circuitry 908) and a corresponding vector of B1 (which was stored in one or more of the VRFs 904 and transferred to the row buffer circuitry 910) together. Similarly, the vector lane circuitry 902-2 multiplies a first vector of A2 to a corresponding vector of B2, . . . , and the vector lane circuitry 902-16 multiplies a first vector of A16 to a corresponding vector of B16 during the first matrix multiplication cycle.

After the first matrix multiplication cycle ends, the vector lanes 902 perform a lane wise rotation and immediately provide the rotated vectors to the MAC circuits 906 (as opposed to storing them at the end of a queue in the column buffer circuitry 322 as was done in FIGS. 5A-5F). Thus, the vector lane circuitry 902-1 multiplies a first vector of A2 to a corresponding vector of B1, the vector lane circuitry 902-2 multiplies a first vector of A3 to a corresponding vector of B2, . . . , and the vector lane circuitry 902-16 multiplies a vector of A1 to a corresponding vector of B16 during the second matrix multiplication cycle. The vector lanes 902 continue performing lane wise rotations and multiplying the rotated A vector as described above until each of the vector lanes 902-1 through 902-16 has obtained a the first vector from each of the sixteen A sub-tiles and used said vector in a matrix multiplication operation.

On the seventeenth cycle, the vector lanes 902 access the second vectors of their original A sub-tiles from the VRFs 904 and multiply the second A vectors to the corresponding B vectors. The foregoing sequence of lane wise rotations then repeats so that the vector lanes 902 use all sixteen of the second A vectors in matrix multiplication operations before accessing the VRFs 904 to obtain the third A vectors. Thus, in this example, the column buffer circuits 908 only obtain a vector from the original A sub-tile once every sixteen matrix multiplication cycles. Similarly, the row buffer circuits 910 only obtain a new vector of their respective B sub-tiles from the VRFs 904 once every sixteen matrix multiplication cycles.

The lane wise rotation technique of FIG. 9A reduces the frequency at which input A sub-tile or B sub-tile data is transferred from the VRFs 904 (as compared to the lane wise rotation technique of FIGS. 5A-5F). In some examples, the MAC circuits 906 stores partial results (e.g., C matrix data) directly in the VRFs 904 to avoid implementing the accumulator memory units 903. Such a configuration is possible because the column buffer circuitry 908 and row buffer circuitry 910 access the VRFs 904 sufficiently infrequently. However, removing the accumulator memory increases the amount of interconnects between the VRFs 904 and the MACs 906. In general, a designer or manufacturer of a VPU described herein can include temporary memory (e.g., the accumulator memory units 903) within the MMC 310 to reduce the latency required to update multiple partial results.

FIG. 9B is a second example implementation of the column buffer circuitry and row buffer circuitry of FIG. 3B. The example of FIG. 9B includes the same components as FIG. 9A, but the column buffer circuits 908 of FIG. 9B have five columns (rather than two as shown in FIG. 9A) and the row buffer circuits 910 have four columns (rather than two as shown in FIG. 9A). Additionally, in the example of FIG. 9B, an entire A sub-tile fits into four columns of a column buffer circuitry 908 with one column left over for data transfer. Similarly, in the example of FIG. 9B, an entire B sub-tile fits into the four columns of a row buffer circuitry 910. In other examples, the VPU of FIG. 9B has different characteristics (e.g., different matrix, tile, and/or sub-tile dimensions).

Using the dimensions of FIG. 9B, a given instance of vector lane circuitry (e.g., 902-1) requires four cycles to load an A sub-tile into its column buffer circuitry 908 and four cycles to load a B sub-tile into its row buffer circuitry 910. In some examples, the column buffer circuitry 908 and row buffer circuitry 910 are loaded concurrently over the same four cycles. The vector lane circuitry 902-1 also, over the course of four cycles, a) computes the outer-multiplication of one A sub-tile column with one B sub-tile row, b) sends the multiplied A sub-tile column to the vector lane circuitry 902-16 during the same cycle as the multiplication, c) receive an A column from the vector lane circuitry 902-2 and store it in the fifth row of the vector lane circuitry 908, d) move the pointers in the column buffer circuitry 908 and row buffer circuitry 910 to the next column and next row, respectively, and e) move the receive pointer of the column buffer circuitry 908 to the column which was just used for the outer multiply (as that data is no longer needed and will be overwritten by the data received from the vector lane circuitry 902-2).

Notably, the four cycles required for the vector lane circuitry 902-1 to implement the foregoing operations a) through e) begin as soon as one column of an A sub-tile is loaded and one row of a B sub-tile is loaded. Thus, the vector lane circuitry 902-1 reads an entire A sub-tile and an entire B sub-tile in the first four cycles and multiplies them together over the course of cycles two through five. After such multiplication, the VRFs 904 are not accessed for another 4*(number_of_lanes−1) cycles. Instead, A sub-tile data is sent around from lane to lane at one column per cycle as described above in FIG. 9A. The vector lane circuitry 902-1 also repeatedly reuses the B sub-tile row by row (e.g., each row of data is used 16 times in FIG. 9B). The B sub-tile data is not being moved as only the pointer is being rotated so that different copies of reused row data are provided to the MACs 906 at each cycle. Accordingly, the VRFs 904 can be accessed in FIG. 9B to process other vector operations, load or store vector register data, etc. during (number_of_lanes−1)*4 cycles in between loads of A sub-tile and B-sub-tile data.

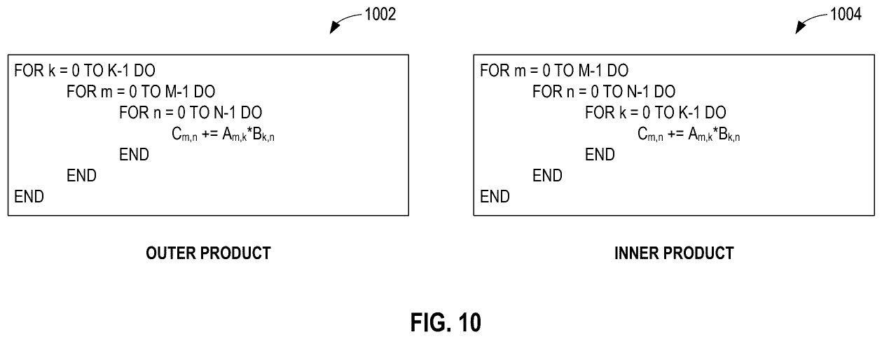

FIG. 10 is an illustrative example of pseudocode used to implement outer product technique and inner product technique for matrix multiplication. FIG. 10 includes example pseudocode 1002 and 1004. FIG. 10 also includes equations (3) and equations (4), which are restated here:

$${C}_{m , n} = {C}_{m , n}^{OLD} + {\sum }_{K = 0}^{K - 1} ( {A}_{m , k} \cdot {B}_{k , n} ) \qquad ( 3 )$$

$$C = {C}^{OLD} + ( A \cdot B ) \qquad ( 4 )$$

Equations (3) and (4) state the same concepts of equations (1) and (2). However, equations (3) and (4) are generalized to any kind of A, B, and C matrices as described in FIG. 4, while equations (1) and (2) describe the specific A, B, and C tiles of FIG. 5. Thus, the A, B, and C matrices of equations (3) and (4) do not include reference numerals but do include variables that represent the matrix dimensions as shown in FIG. 4: A is an [M×K] matrix, B is a [K×N] matrix, and C is an [M×N] matrix. Thus, A_{m,k} represents an element from the mth row and kth column of the A matrix, where m is any integer between 0 and M-1 and k is any integer between 0 and K-1. Accordingly, VPUs implemented according to the examples described herein can exhibit performance improvements over known VPUs (e.g., lower cost, complexity, power consumption, etc. as described above) at different magnitudes of matrix, tile, and sub-tile dimensions.

Using the above nomenclature, a C matrix can be computed programmatically by iterating through all possible combinations of variables in equation (5):

$${C}_{m , n} + = {A}_{m , k} * {B}_{m , k} \qquad ( 5 )$$

The three variables m, k, and n therefore require three nested loops of operations. The pseudocode 1002 shows one possible implementation of the foregoing C matrix computation in which the outermost loop iterates over the variable k. Such a configuration is referred to as an outer product in linear algebra because in the pseudocode 1002, a given iteration of equation (5) describes the multiplication of one vector (e.g., a vector from an A sub-tile) to another vector (e.g., a vector form a B sub-tile) to produce a matrix (e.g., a partial result of C). In machine learning applications, the pseudocode 1002 may be referred to as an output stationary configuration because to implement such a configuration, output data (e.g., the C matrix partial results) remain fixed (e.g., stationary) in a given memory location of the vector lanes while the activation and weight values move into and out of the MMC 310. Accordingly, VPUs in the examples described above are implemented in a weight stationary configuration.

The pseudocode 1004 shows a different possible implementation of the foregoing C matrix computation in which the outermost loop iterates over the variable m. Such a configuration is referred to as an inner product in linear algebra because in the pseudocode 1004, a given iteration of equation (5) describes a full dot product including the multiplication of two vectors (e.g., a column of an A sub-tile and a row of a B sub-tile) and the summation of the products. In machine learning applications, the pseudocode 1004 may be referred to as a weight stationary configuration because to implement such a configuration, weight data (e.g., the B matrix data) remains fixed in place while the activation data and output data are transferred into and out of the MMC 310. Advantageously, the examples described herein enable a VPU to implement an output stationary configuration (as shown above), a weight stationary configuration, or other configurations (e.g., an input stationary configuration) by adjusting the execution plan provided to the VPU before matrix multiplication begins.

FIG. 11 is an illustrative example of instructions from an Instruction Set Architecture (ISA) that supports the matrix multiplier circuitry of FIG. 2. A user space program can develop an execution plan as described herein by generating machine-readable instructions according to the ISA of FIG. 11.

The instructions of FIG. 11 shows operation codes in bold, followed by a) an output variable that is generated by executing the operation code and b) one or more input variables that are used by a VPU described herein to execute the operation code. In some examples, the input variables are referred to as input operands or input arguments.

The VPU 110 executes the instruction Vector Matrix Tile Shape (VMTS) by providing the user space program that provided with recommended tile shape (stored in the variable RD). The VPU 110 generates the recommended tile shape based on the arguments register source one (RS1) (in which the user space program describes the dimensions of a matrix), SEW (in which the user space program describes the width of a single element in the RS1 matrix), MTYPE (in which the user space program describes whether the RS1 matrix is an A, B, or C matrix), and ORDER (in which the user space program describes whether the RS1 matrix is stored in row major or column major order).

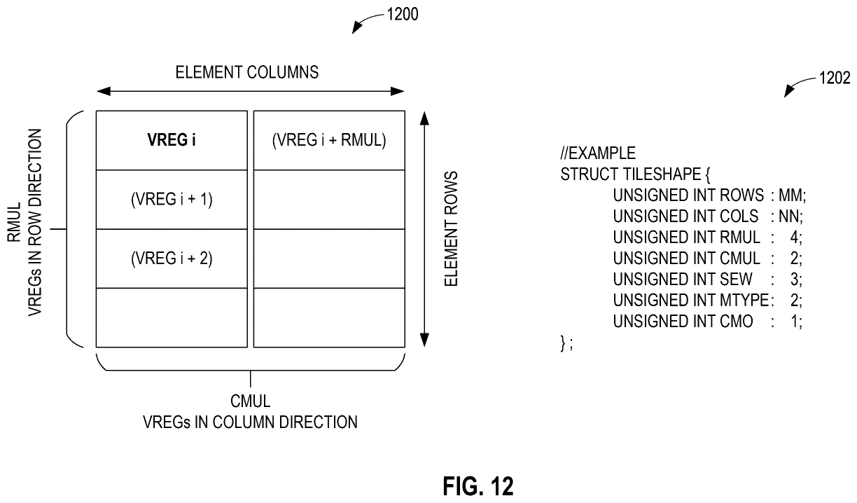

The VPU 110 executes the instruction Vector Matrix Load Tile (VMLT) by loading a tile into the vector registers identified by VD. The VPU 110 executes VMLT based on the arguments register source two (RS2)(in which the user space program describes where the data to be loaded is currently stored), RS1, (in which the user space program describes the dimensions of the matrix that includes the tile), and TS (in which the user space program describes the dimensions of the tile to be loaded). The TS argument is described further in connection with FIG. 12.

The VPU 110 executes the instruction Vector Matrix Multiply Accumulate (VMMAC) by multiplying an A tile (represented by VA) and a B tile (represented by VB) to produce a C tile (represented by VC). The VPU 110 does so based on the arguments TS_{C}, TS_{A}, and TS_{B}, which represent the dimensions of the C, A, and B tile respectively. TS_{C}, TS_{A}, and TS_{B} are described further in connection with FIG. 12. As used above and herein, the term “tile shapes” such as TS_{C}, TS_{A}, and TS_{B} are characteristics of tiles that refer to the same information as the terms “tile size” or “tile dimensions” described above.

The VPU 110 executes the instruction Vector Matrix Store (VMST) by storing a tile into RS2. The VPU 110 does so based on the arguments VD (which describe the vector registers where the tiles is currently stored), RS1 (in which the user space program describes the dimensions of the matrix that includes the tile) and TS (in which the user space program describes the dimensions of the tile to be stored). The TS argument is described further in connection with FIG. 12.

FIG. 12 is an illustrative example of the tile structure argument used in FIG. 11. FIG. 12 includes an example tile 1200 and example pseudocode 1202. The example 1200 represents the structure of any tile described herein. The pseudocode 1202 describes a data structure that describes the shape of the 1200. In doing so, the pseudocode represents the information provided in a Tile Shape (TS) argument in the ISA of FIG. 11.

A tile is composed of multiple elements arranged in rows and columns (e.g., a matrix). Thus, the pseudocode 1202 shows the TS argument includes integer values ‘ROWS’ and ‘COLS’ that describe the number of rows of elements and number of columns of elements in a tile.

The elements of a tile are distributed across one or more vector registers (VREGs). Accordingly, the memory location of a given element within the tile depends on the indexing of the VREGs that store tile. Thus, the pseudocode 1202 shows the TS argument includes integer values ‘RMUL and ‘CMUL’ that describe the number of rows of VREGs and number of columns of VREGs in a tile. In this example, RMUL=4 and CMUL=2 because elements of the tile 1200 is stored in four rows and two columns of VREGs. The pseudocode 1202 shows the TS argument also includes an integer SEW that describes the single element width of the tile 1200, an integer MTYPE that describes whether the tile 1200 is an A tile, B tile, or C tile, and an integer CMO that indicates if the 1200 is stored in column major order.

In general, the number of arguments that a given matrix unit command can support is limited. In this example, matrix unit command argument cannot support all eight VREGs. Instead, a user space program creates a group of vector registers that has size (RMUL*CMUL). The user space program names the group after the first vector register (which has index i in FIG. 12) and provides the group as the argument to the matrix unit command.

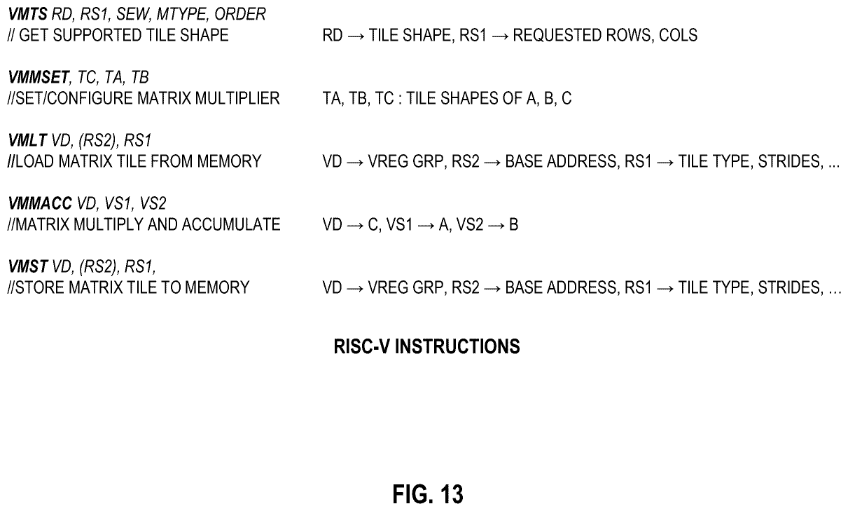

FIG. 13 is an illustrative example of instructions within the RISC—V ISA that support the matrix multiplier circuitry of FIG. 2. While the RISC-V ISA includes the same operation codes described in FIG. 11, the RISC-V ISA does not currently support tile shape as a valid argument for VMTS, VMMACC, or VMST. However, the RISC-V includes instructions such as Vector Matrix Multiplier Set (VMMSET) that can be combined with RISC-V versions of VMTS, VMMACC, and/or VMST to reach the same logical effect as the instructions of FIG. 11. Thus, a user space program can develop an execution plan interpretable by the VPU 110 by generating machine-readable instructions according to the examples described herein. Machine-readable instructions used to form an execution plan include but are not limited to the ISA of FIGS. 11 and 12 or the RISC-V ISA of FIG. 13. More generally, the examples described herein can be supported by one or more ISAs that are portable and adaptable to a wide variety of hardware implementations. FIGS. 11 and 13 also show additional characteristics of matrices, tiles, and sub-tiles: in some examples, matrices, tiles, and/or sub-tiles can be described as arguments to functions within machine-readable instructions.

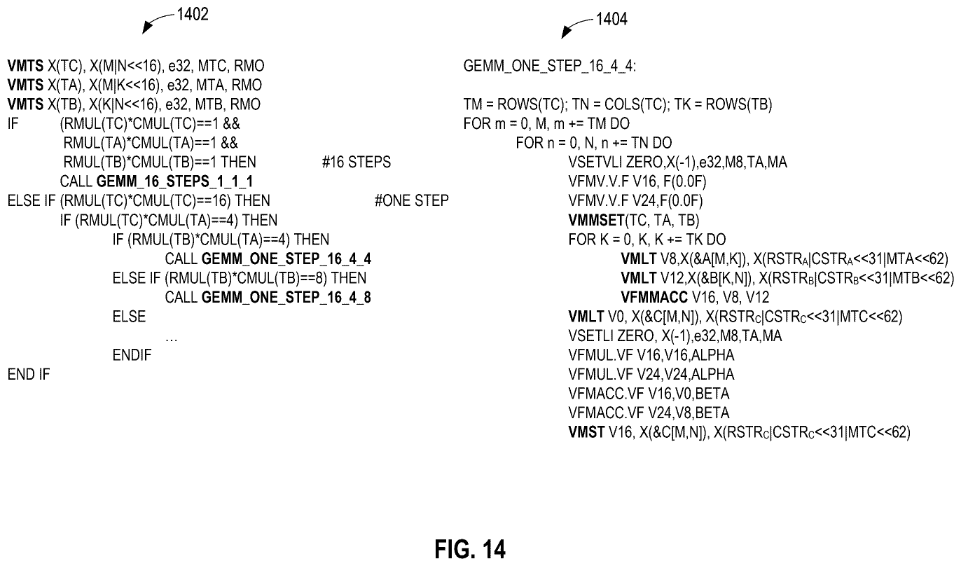

FIG. 14 is an illustrative example of machine-readable instructions that implement an execution plan for the VPU of FIG. 1. FIG. 14 includes code snippets 1402 and 1404. The two code snippets represent two portions of the same execution plans. Both code snippets 1402 and 1404 (and the execution plan as a whole) are written in compliance with the ISA of FIG. 11. In some examples, information required to form an execution plan (e.g., dimensions and other characteristics of matrices, tiles, and sub-tiles, policy instructions, etc.) may be stored in one or more accessible memory devices. For example, the accessible memory devices can be read from or written to by one or more of the software applications 102.

In the code snippet 1402, a user space program begins the execution plan with three lines that each use the VMTS instruction. The instructions provide the VPU 110 with the A, B, and C matrix dimensions (which are M, N, and K as described above) and ask the VPU 110 to recommend dimensions for C tiles, A tiles, and B tiles. The user space program then checks, using IF statements that accept the RMUL and CMUL portions of the tile shape data structure from FIG. 12 as arguments, if each of the recommended A, B, and C tile dimensions would be stored within a single vector register. If the foregoing condition is true, then the code snippet 1402 shows the user space program instructs the VPU 110 to distribute the C tile into as many vector registers as possible. The code snippet 1402 therefore instructs the VPU 110 to reuse the A tiles and B tiles multiple times, thereby increasing arithmetic intensity. Alternatively, if the VPU 110 recommends a C tile with dimensions that are stored across 16 vector registers, and recommends a and B tiles with dimensions that stored across 4 vector registers each, then the code snippet 1402 shows that the user space program implements the recommendation by instructing the VPU 110 to load and store data accordingly.

In the code snippet 1404, the user space program divides the selected tile shapes into smaller pieces (e.g., sub-tiles) that can be fed into the various MMCs 310. The user space program then instructs the MMCs 310 to perform the matrix multiplication using specific sub-tiles in a specific sequence. In the code snippet 1404, such instructions includes the FOR loop that iterates over the variable K and the various instructions that follow. In other examples, a user space program creates an execution plan composed of different machine-readable instructions, which in turn cause the VPU 110 to perform matrix multiplication differently.

While an example manner of implementing the compute device 100 of FIG. 1 is illustrated in FIG. 1, one or more of the elements, processes, and/or devices illustrated in FIG. 1 may be combined, divided, re-arranged, omitted, eliminated, and/or implemented in any other way. Further, the software applications 102, the operating system 104, the SPU 106, the VPU 110, and/or, more generally, the example compute device 100 of FIG. 1, may be implemented by hardware alone or by hardware in combination with software and/or firmware. Thus, for example, any of the software applications 102, the operating system 104, the SPU 106, the VPU 110, and/or, more generally, the example compute device 100, could be implemented by programmable circuitry, such as one or more chiplets, one or more processor cores, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing unit(s) (VPUs), and/or field programmable logic device(s) (FPLD(s)) such as FPGAs in combination with machine-readable instructions (e.g., firmware or software). Further still, the example compute device 100 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine-readable instructions, which may be executed by programmable circuitry to implement and/or instantiate the compute device 100 of FIG. 1 and/or representative of example operations which may be performed by programmable circuitry to implement and/or instantiate the compute device 100 of FIG. 1, are shown in FIG. 15. The machine-readable instructions may be one or more executable programs or portion(s) of one or more executable programs for execution by programmable circuitry such as the programmable circuitry 1812 shown in the example programmable circuitry platform 1800 discussed below in connection with FIG. 18 and/or may be one or more function(s) or portion(s) of functions to be performed by the example programmable circuitry (e.g., an FPGA) discussed below in connection with FIGS. 19 and/or 20. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 15, many other methods of implementing the example compute device 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, chiplet(s), discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, a chiplet and/or an array of chiplets, etc.)). As used herein, programmable circuitry includes any type(s) of circuit that may be programmed to perform a desired function such as, for example, a CPU, a core, a chiplet, an arrays of chiplets, a GPU, a VPU, and/or an FPGA. The programmable circuitry may include one or more CPUs, one or more cores, one or more chiplets, one or more GPUs, one or more VPUs, and/or one or more FPGAs located in the same package (e.g., the same integrated circuit (IC) package or in two or more separate housings), one or more one or more CPUs, one or more cores, one or more chiplets, one or more GPUs, one or more VPUs, and/or one or more FPGAs in a single machine, multiple CPUs, cores, chiplets, GPUs, VPUs, and/or FPGAs distributed across multiple servers of a server rack, and/or multiple CPUs, cores, chiplets, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 15 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 15 is a flowchart representative of example machine-readable instructions and/or example operations that may be executed, instantiated, and/or performed by example programmable circuitry to implement matrix multiplication in the compute device of FIG. 1. While the following description refers to the software application 102-1, the example flowchart of FIG. 15 may be implemented in part by any user space program (e.g., any of the software applications 102).

The example machine-readable instructions and/or the example operations 1500 of FIG. 15 begin when the software application 102-1 queries the VPU 110 by providing matrix dimensions as an input. (Block 1502). The software application 102-1 explicitly defines at least the dimensions of the A matrix and the B matrix as described above. In some examples, the VPU 110 implicitly determines the dimensions of the C matrix based on the dimensions of the A matrix and the B matrix. In general, the query of block 1502 is a request by the software application 102-1 for the VPU 110 to generate tile dimension recommendations. In the examples of FIGS. 11, 13, and 14, the software application 102-1 performs the query using the VMTS instruction. In other examples, the software application 102-1 performs the query using one or more instructions that comply with a different ISA.

The VPU 110 responds to the query with tile dimension recommendations. (Block 1504). Thus, the VPU 110 recommends how to divide the A matrix into one or more A tiles, how to divide the B matrix into one or more B tiles, and how to divide the C matrix into one or more C tiles. The VPU 110 considers both the matrix dimensions of block 1502 and the hardware dimensions of the VPU 110 when providing the recommendation of block 1504. The hardware dimensions of the VPU 110 may include but are not limited to the total number of vector lanes 206 within the VPU 110, the number and location of ring structures of interconnects between the vector lanes 206, the number of VRFs 302 per vector lane, whether the bus 312-2 provides matrix data directly to the MMC 310 or provides the matrix data through a mux 316 that is shared with the pipeline circuitry 304, the number of column buffer circuitry 322 instances in the MMC 310, the number of row buffer circuitry 320 instances in the MMC 310, the amount of memory in a given instance of the column buffer circuitry 322 or row buffer circuitry 320, the number of logic units per instance of the MMC 310, how the logic units are organized into rows and columns within the MMC 310, whether the logic units are MAC circuits, FMA units, or some other architecture, whether the MMC 310 includes accumulator memory 326 and a store buffer 328 or stores partial results directly in the VRFs 302, etc.

In many examples, the VPU 110 determines the foregoing inputs support multiple possible tile dimensions. In such examples, the VPU 110 selects a given set of tile dimensions to recommend at block 1504 based on the general principles of increasing data efficiency and increasing arithmetic intensity. For example, the VPU 110 strives to create tile dimensions such that the number of sub-tiles per tile is evenly divisible by the number of vector lanes assigned to the matrix multiplication, thereby maximizing computational efficiency when performing lane wise rotations as described above. For example, in a non-limiting implementation, the VPU's 110 recommendation logic may first identify all possible tile dimensions that result in the number of sub-tiles being evenly divisible by the number of assigned vector lanes. From this subset, the VPU may then recommend a dimension that results in the largest possible sub-tile size to minimize loop overhead, thereby providing a balance between parallelism and efficiency. Notably, sub-tile dimensions are pre-determined based on the hardware dimensions of the VPU 110 so that a single instance of the vector lane circuitry 206-1 multiplies one A sub-tile and one B sub-tile to produce one C sub-tile over the course of one matrix multiplication cycle as described above. However, the VPU 110 can still change the number of sub-tiles per tile and the arrangement of sub-tiles (e.g., number of columns and rows) within a tile based on the particular matrix dimensions that are provided by the software applications 102.

The software application 102-1 selects tile dimensions and determines a corresponding matrix multiplication technique. (Block 1506). In selecting tile dimensions, the software application 102-1 can, but is not required to, accept the recommendation from the VPU 110 at block 1504. The software application 102-1 may choose to disregard the recommendation from the VPU 110 for any reason. For example, suppose a relatively weak processor requires a relatively large number of VREGs to load A and B input matrix data. To increase the number of VREGs in such an example, a user space program may chooses tile dimensions that are smaller than what the VPU 110 can actually support. In doing so, the user space program ignores the tile recommendations of block 1504.

The software application 102-1 also determines a matrix multiplication technique based on the selected tile dimensions. (Block 1508). For example, the software application 102-1 may determine whether, to multiply a given A tile to a given B tile, the VPU 110 performs only lane wise rotation operations (as shown in FIGS. 5A-5F above), only broadcasts the same sub-tile data to multiple vector lanes simultaneously (as shown in FIGS. 6A-6C) above, or performs a combination of lane wise rotations and broadcasts (as shown in FIGS. 7A-7D above). More generally, the software application 102-1 may generate any type of function at block 1508 that a) is compatible with an ISA supported by the VPU 110 and b) instructs the VPU 110 how to perform matrix multiplication in a manner that is consistent with the example VPU hardware descriptions provided above. In one example, the software application 102-1 generates the matrix multiplication function from the code snippet 1404 at block 1508. In other examples, the software application 102-1 determines a different matrix multiplication technique at block 1508.

The software application configures the VPU 110 based on one or more of the tile dimensions and the matrix multiplication technique. (Block 1510). The software application may perform the configuration operations of block 1510 by generating CSR instructions 214 as described above. Such CSR instructions 214 may assign two or more of the vector lanes 206 sharing a ring structure of interconnects to work together to perform matrix multiplication, assign specific operation instructions 212 (which implement various portions of the matrix multiplication technique) to specific vector lanes 206, etc.

Once configured, the configured VPU 110 performs the matrix multiplication requested by the software application. (Block 1512). The VPU 110 performs the operations of block 1512 based on at least the matrix multiplication technique and the selected tile dimensions of block 1506 and 1508. In some examples, the software application 102-1 may provide the foregoing information the VPU 110 as a set of machine-readable instructions referred to as an execution plan. In some examples (such as FIG. 14), the execution plan also includes the query of block 1502. The machine-readable instructions and/or operations 1500 end after block 1512.

FIGS. 16, 17A, 17B, and 18 include example computing architectures in which any of the techniques and configurations above may be implemented.

FIG. 16 illustrates an example hardware arrangement of an example data center 1600 used to provide multiple examples or instances of a computing system (e.g., the programmable circuitry platform 1800, described below), with each example of the computing system identified as a respective platform (e.g., the platform 1630, described below). The data center 1600 includes example data center infrastructure 1601, an example data center network fabric 1602, and an example power distribution unit 1603 to support multiple racks of compute platforms, with a single instance of an example rack 1610 depicted. The data center infrastructure 1601 may provide physical components that host the compute platform hardware, storage components, and/or networking equipment. The data center network fabric 1602 may include switches and/or networking components to support data flows among various compute platforms and storage devices throughout the data center. The power distribution unit 1603 may include components to distribute and/or control power among the various compute platforms, networking, and storage devices.

The rack 1610 of FIG. 16 includes, but is not limited to, example cooling infrastructure 1611, an example network interface 1612, and/or other related physical components to support discrete instances of multiple chassis. The rack 1610 provides power, connectivity, and/or cooling to each of the multiple chassis in a single rack, with a single instance of a chassis 1620 in the example of in FIG. 16. The chassis 1620 includes, but is not limited to, example cooling infrastructure 1621, an example chassis network fabric 1622, and an example power supply 1623, which provides cooling, network connectivity, and/or power to multiple platforms within the chassis. Although a single instance of an example platform 1630 is illustrated in FIG. 16, in some examples, a common data center rack configuration may include dozens of chassis, with each chassis to support a number of platforms depending on the physical size of the platform hardware and/or supporting equipment.

The platform 1630 of FIG. 16 may be referred to as a server or node, depending on the use case for the platform 1630 and the data center 1600. The platform 1630 includes but is not limited to examples of a discrete computing system hosted on a single board. In FIG. 16, the platform 1630 is illustrated as hosting a first example chip assembly 1640A and a second example chip assembly 1640B on a first board provided by a printed circuitry board (PCB) or other platform board, shown as an example PCB 1631. In some examples, the platform 1630 may include only one chip package, whereas the PCB 1631 includes interconnection of multiple chip assemblies via an interface (e.g., a peripheral component interconnect express (PCIe) interface). Additional chip packages and components may also be hosted on the PCB 1631.

Some examples of the chip assembly 1640A, 1640B of FIG. 16 may be termed as a System-on-Chip (SoC) package, as modular chiplets that perform different functions are integrated into a single package-even though this chip package is composed of multiple dies unlike a traditional SoC design that uses a single die. Other examples of the chip assembly 1640A, 1640B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 1640A and the second chip assembly 1640B of FIG. 16 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 1640A of FIG. 16 includes a I/O Hub chiplet 1641, chiplets 1642, and a power supply 1643. These components may be hosted on an interposer that is designed to connect multiple dies and/or components within a single semiconductor package (e.g., chip package). In some examples, the chiplets 1642 may be manufactured and/or sourced separately and later assembled into the chip package to create the chip assembly 1640A. Various connections may be provided among the chiplets 1642, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

FIG. 17A illustrates an example arrangement of an example chip assembly 1740A (e.g., a multi-processing core example of the first chip assembly 1640A or the second chip assembly 1640B of FIG. 16), with expanded views of the chiplets and processing units included herein. In FIG. 17A the chip assembly 1740A, which may constitute a SoC, SoP, SiP, and/or other type of chip package, includes chiplets such as an example chiplet 1710A, an example chiplet 1710B, etc. and associated on-package memory (e.g., high-speed memory) such as 3D-stacked, High Bandwidth Memory (HBM) instances (shown as an example HBM 1720A, an example HBM 1720B, interfaces (e.g., UCIe interfaces) shown as an example UCIe 1721A, an example UCIe 1721B, and an example I/O hub 1730 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 1710A, 1710B of FIG. 17A include multiple processing units and the example processing units 1700A, 1700B, 1700C, 1700D include one or multiple cores, respectively. For example, the chiplet 1710A of FIG. 17A includes four processing units (the processing units 1700A, 1700B, 1700C, 1700D) and an example Level 3 (L3) cache 174. The processing units 1700A, 1700B, 1700C, 1700D may include one or multiple processing cores, one or multiple caches, other processing units and/or passive and/or active elements. For example, processing unit 1700A includes two cores (an example core 1701A and an example core 1701B), vector processing unit 1702, and an example level 2 (L2) cache 173. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 17B is an example arrangement of an example chip assembly 1740B (e.g., a multi-chiplet high-performance computing (HPC) example of chip assembly 1640A, 1640B), adapted for HPC applications (e.g., parallel processing operations involving thousands, millions, or more of processors and/or cores operating simultaneously). The example chip assembly 1740B illustrates placement as a SiP, SoC, and/or other package onto a platform board (e.g., the PCB 1631 of FIG. 16). The platform board may be in a data center (e.g., the data center 1600 of FIG. 16) or in a standalone deployment setting (e.g., in a standalone computer system, mobile computing device, autonomous device, etc.).

The chip assembly 1740B of FIG. 17B is composed of multiple chiplets, shown with four chiplets, including example chiplets 1710C, 1710D, 1710E, 1710F. The chiplets 1710C, 1710D, 1710E, 1710F include multiple processing units, such as thirty two processing units with a corresponding level 3 (L3) cache for each processing unit. The processing units may include one or multiple cores, such as an example single-core processing unit 1700E shown as part of the chiplet 1710C. The chip assembly 1740B also includes corresponding memory resources, such as HBM elements corresponding to respective banks of processing units (e.g., HBM 1720B and HBM 1720C corresponding respective sets of processing units of chiplet 1710C), UCIe interfaces, and/or an IO Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 1700, the chiplet 1710, the chip 1640, and/or the platform 1630 of FIGS. 16, 17A, and/or 17B) to perform operations described above for electronic systems or devices (e.g., to perform matrix multiplication, etc.). It should be further understood that software, including one or more machine-readable instructions, that facilitate processing and operations as described above may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

FIG. 18 is a block diagram of an example programmable circuitry platform 1800 structured to execute and/or instantiate the example machine-readable instructions and/or the example operations of FIG. 15 to implement the compute device 100 of FIG. 1. The programmable circuitry platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1800 of the illustrated example includes programmable circuitry 1812. The programmable circuitry 1812 of the illustrated example is hardware. For example, the programmable circuitry 1812 can be implemented by one or more integrated circuits, logic circuits, chiplets, cores, FPGAs, microprocessors, CPUs, GPUs, VPUs, DSPs, and/or microcontrollers from any desired family or manufacturer. In some examples, the programmable circuitry 1812 may be implemented by ISAs that include but are not limited to a reduced instruction set computer (RISC)-V architecture and/or a chiplet (e.g., the chiplet assemblies 1640A, 1640B, 1740A, 1740B of FIGS. 9, 10A and/or 10B). The programmable circuitry 1812 may be implemented by one or more semiconductor based (e.g., silicon based) devices. In this example, the programmable circuitry 1812 implements the software applications 102, the SPU 106, and the VPU 110.

In some examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of first circuitry at one point in time and reused by a second circuit in the first circuitry, or by a third circuit in a second circuitry at a different time.

The programmable circuitry 1812 of the illustrated example includes a local memory 1813 (e.g., a cache, registers, etc.). The programmable circuitry 1812 of the illustrated example is in communication with main memory 1814, 1816, which includes a volatile memory 1814 and a non-volatile memory 1816, by a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817. In some examples, the memory controller 1817 may be implemented by one or more integrated circuits, logic circuits, microcontrollers from any desired family or manufacturer, or any other type of circuitry to manage the flow of data going to and from the main memory 1814, 1816.

The programmable circuitry platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1820 may include an output interface, such as an interface connected to a display device, an input interface such as an interface connected to an alphanumeric input device or a user interface (UI) navigation device, or a communication interface. In some examples, a connected I/O device may also include a display device, an alphanumeric input device, and/or a navigation device that is integrated into a single unit, such as a touch screen display. The communication interface may provide a connection with a network interface device used to transmit and/or receive electronic signals on the network 1826. The programmable circuitry platform 1800 may also include other interfaces or hardware in connection with a signal generation device (e.g., an audio or radio signal generation device), an output controller (e.g., for connection with a serial, universal serial bus (USB), parallel, and/or other wired or wireless connection such as which uses via infrared (IR) and/or near field communication (NFC) technologies), an input controller (e.g., for connection with sensors or peripheral devices), etc.

In the illustrated example, one or more input devices 1822 are connected to the interface circuitry 1820. The input device(s) 1822 permit(s) a user (e.g., a human user, a machine user, etc.) to enter data and/or commands into the programmable circuitry 1812. The input device(s) 1822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1824 are also connected to the interface circuitry 1820 of the illustrated example. The output device(s) 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1800 of the illustrated example also includes one or more mass storage discs or devices 1828 to store firmware, software, and/or data. Examples of such mass storage discs or devices 1828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1832, which may be implemented by the machine-readable instructions of FIG. 15, may be stored in the mass storage device 1828, in the volatile memory 1814, in the non-volatile memory 1816, and/or on at least one non-transitory computer readable storage medium such as a CD or DVD which may be removable. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1832.

The instructions 1832 may reside, during execution and/or other operation of the programmable circuitry platform 1800, completely, or at least partially, within the volatile memory 1814, within non-volatile memory 1816, within the local memory 1813, within a removable storage, within a non-removable storage, and/or within the programmable circuitry 1812. Thus, any combination of the programmable circuitry 1812, the volatile memory 1814, the non-volatile memory 1816, the local memory 1813, and/or a storage device of the removable storage or non-removable storage may constitute a machine-readable medium or media. The instructions 1832, when loaded and executed by the programmable circuitry 1812, may invoke or utilize a defined instruction set 1832 of the programmable circuitry 1812, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. A RISC-V architecture and instruction set is one of several available architectures and instruction sets that may be used in examples of the compute components (e.g., the programmable circuitry 1812) described herein.

FIG. 19 is a block diagram of an example implementation of the programmable circuitry 1812 of FIG. 18. In this example, the programmable circuitry 1812 of FIG. 18 is implemented by a microprocessor 1900. For example, the microprocessor 1900 may be a general-purpose microprocessor (e.g., general-purpose microprocessor circuitry). The microprocessor 1900 executes some or all of the machine-readable instructions of the flowcharts of FIG. 15 to effectively instantiate the circuitry of FIG. 1 as logic circuits to perform operations corresponding to those machine-readable instructions. In some such examples, the circuitry of FIG. 1 is instantiated by the hardware circuits of the microprocessor 1900 in combination with the machine-readable instructions. For example, the microprocessor 1900 may be implemented by multi-core hardware circuitry such as a CPU, a DSP, a GPU, a VPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine-readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine-readable instructions and/or operations represented by the flowcharts of FIG. 15.

The cores 1902 may communicate by a first example bus 1904. In some examples, the first bus 1904 may be implemented by a communication bus to effectuate communication associated with one(s) of the cores 1902. For example, the first bus 1904 may be implemented by at least one of an Inter-Integrated Circuit (I2C) bus, a Serial Peripheral Interface (SPI) bus, a PCI bus, or a PCIe bus. Additionally or alternatively, the first bus 1904 may be implemented by any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2 cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1814, 1816 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the local memory 1920, and a second example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples, the AL circuitry 1916 also performs floating-point operations. In yet other examples, the AL circuitry 1916 may include first AL circuitry that performs integer-based operations and second AL circuitry that performs floating-point operations. In some examples, the AL circuitry 1916 may be referred to as an Arithmetic Logic Unit (ALU).

The registers 1918 are semiconductor-based structures to store data and/or instructions such as results of one or more of the operations performed by the AL circuitry 1916 of the corresponding core 1902. For example, the registers 1918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure, such as by being distributed throughout the core 1902 to shorten access time. The second bus 1922 may be implemented by at least one of an I2C bus, a SPI bus, a PCI bus, or a PCIe bus.

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages.

The microprocessor 1900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1900, in the same chip package as the microprocessor 1900 and/or in one or more separate packages from the microprocessor 1900.

FIG. 20 is a block diagram of another example implementation of the programmable circuitry 1812 of FIG. 18. In this example, the programmable circuitry 1812 is implemented by FPGA circuitry 2000. For example, the FPGA circuitry 2000 may be implemented by an FPGA. The FPGA circuitry 2000 can be used, for example, to perform operations that could otherwise be performed by the example microprocessor 1900 of FIG. 19 executing corresponding machine-readable instructions. However, once configured, the FPGA circuitry 2000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1900 of FIG. 19 described above (which is a general purpose device that may be programmed to execute some or all of the machine-readable instructions represented by the flowchart(s) of FIG. 15 but whose interconnections and logic circuitry are fixed once fabricated), the FPGA circuitry 2000 of the example of FIG. 20 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIG. 15. In particular, the FPGA circuitry 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 15. As such, the FPGA circuitry 2000 may be configured and/or structured to effectively instantiate some or all of the operations/functions corresponding to the machine-readable instructions of the flowchart(s) of FIG. 15 as dedicated logic circuits to perform the operations/functions corresponding to those software instructions in a dedicated manner analogous to an ASIC. Therefore, the FPGA circuitry 2000 may perform the operations/functions corresponding to the some or all of the machine-readable instructions of FIG. 15 faster than the general-purpose microprocessor can execute the same.

In the example of FIG. 20, the FPGA circuitry 2000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

The FPGA circuitry 2000 of FIG. 20, includes example input/output (I/O) circuitry 2002 to obtain and/or output data to/from example configuration circuitry 2004 and/or external hardware 2006. For example, the configuration circuitry 2004 may be implemented by interface circuitry that may obtain a binary file, which may be implemented by a bit stream, data, and/or machine-readable instructions, to configure the FPGA circuitry 2000, or portion(s) thereof. In some such examples, the configuration circuitry 2004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2006 may be implemented by external hardware circuitry. For example, the external hardware 2006 may be implemented by the microprocessor 1900 of FIG. 19.

The FPGA circuitry 2000 also includes an array of example logic gate circuitry 2008, a plurality of example configurable interconnections 2010, and example storage circuitry 2012. The logic gate circuitry 2008 and the configurable interconnections 2010 are configurable to instantiate one or more operations/functions that may correspond to at least some of the machine-readable instructions of FIG. 15 and/or other desired operations. The logic gate circuitry 2008 shown in FIG. 20 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations/functions. The logic gate circuitry 2008 may include other electrical structures such as look-up tables (LUTs), registers (e.g., flip-flops or latches), multiplexers, etc.

The configurable interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example dedicated operations circuitry 2014. In this example, the dedicated operations circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the programmable circuitry 1812 of FIG. 18, many other approaches are contemplated. For example, FPGA circuitry may include an on-board CPU, such as one or more of the example CPU 2020 of FIG. 19. Therefore, the programmable circuitry 1812 of FIG. 18 may additionally be implemented by combining at least the example microprocessor 1900 of FIG. 19 and the example FPGA circuitry 2000 of FIG. 20. In some such hybrid examples, one or more cores 1902 of FIG. 19 may execute a first portion of the machine-readable instructions represented by the flowchart(s) of FIG. 15 to perform first operation(s)/function(s), the FPGA circuitry 2000 of FIG. 20 may be configured and/or structured to perform second operation(s)/function(s) corresponding to a second portion of the machine-readable instructions represented by the flowcharts of FIG. 15, and/or an ASIC may be configured and/or structured to perform third operation(s)/function(s) corresponding to a third portion of the machine-readable instructions represented by the flowcharts of FIG. 15.

It should be understood that some or all of the circuitry of FIG. 1 may, thus, be instantiated at the same or different times. For example, same and/or different portion(s) of the microprocessor 1900 of FIG. 19 may be programmed to execute portion(s) of machine-readable instructions at the same and/or different times. In some examples, same and/or different portion(s) of the FPGA circuitry 2000 of FIG. 20 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1900 of FIG. 19 may execute machine-readable instructions in one or more threads executing concurrently and/or in series. In some examples, the FPGA circuitry 2000 of FIG. 20 may be configured and/or structured to carry out operations/functions concurrently and/or in series. Moreover, in some examples, some or all of the circuitry of FIG. 1 may be implemented within one or more virtual machines and/or containers executing on the microprocessor 1900 of FIG. 19.

In some examples, the programmable circuitry 1812 of FIG. 18 may be in one or more packages. For example, the microprocessor 1900 of FIG. 19 and/or the FPGA circuitry 2000 of FIG. 20 may be in one or more packages. In some examples, an XPU may be implemented by the programmable circuitry 1812 of FIG. 18, which may be in one or more packages. For example, the XPU may include a CPU (e.g., the microprocessor 1900 of FIG. 19, the CPU 2020 of FIG. 20, etc.) in one package, a DSP (e.g., the DSP 2022 of FIG. 20) in another package, a GPU in yet another package, and an FPGA (e.g., the FPGA circuitry 2000 of FIG. 20) in still yet another package.

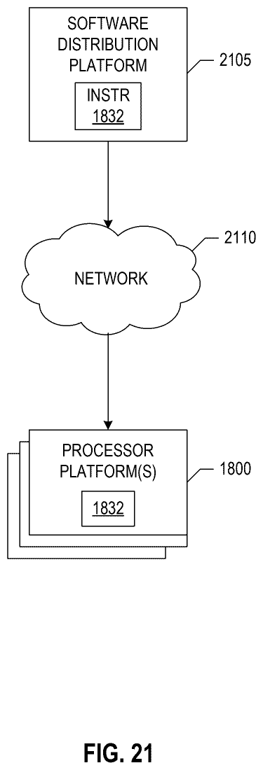

A block diagram illustrating an example software distribution platform 2105 to distribute software such as the example machine-readable instructions 1832 of FIG. 18 to other hardware devices (e.g., hardware devices owned and/or operated by third parties from the owner and/or operator of the software distribution platform) is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine-readable instructions 1832 of FIG. 18. The third parties may be consumers, users, retailers, OEMs, etc., who purchase and/or license the software for use and/or re-sale and/or sub-licensing. In the illustrated example, the software distribution platform 2105 includes one or more servers and one or more storage devices. The storage devices store the machine-readable instructions 1832, which may correspond to the example machine-readable instructions of FIG. 15, as described above. The one or more servers of the example software distribution platform 2105 are in communication with an example network 2110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1832 from the software distribution platform 2105. For example, the software, which may correspond to the example machine-readable instructions of FIG. 15, may be downloaded to the example programmable circuitry platform 1800, which is to execute the machine-readable instructions 1832 to implement the compute device 100. In some examples, one or more servers of the software distribution platform 2105 periodically offer, transmit, and/or force updates to the software (e.g., the example machine-readable instructions 1832 of FIG. 18) to ensure improvements, patches, updates, etc., are distributed and applied to the software at the end user devices. Although referred to as software above, the distributed “software” could alternatively be firmware.

The instructions 1832 may be transmitted or received over the network 2110 using a transmission medium via the interface circuitry 1820 of FIG. 18and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 802.11 family of standards known as Wi-Fi®), IEEE 802.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.=

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, chiplets that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that reduce cost, reduce complexity, and increase performance of matrix multiplication operations in a Vector Processor Unit (VPU). Disclosed systems, apparatus, articles of manufacture, and methods improve the efficiency of using a computing device by implementing a comparatively small instance of matrix multiplier circuitry within a vector lane of a VPU, implementing a ring structure of interconnects to create a sequence of MMC communication between vector lanes, and by implementing an ISA in which the VPU can recommend tile dimensions to a user space program and adjust its technique for performing matrix multiplication operations based on the user space program. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for vector lane matrix multiplication are disclosed herein. Further examples and combinations thereof include the following.

Example 1 includes a Vector Processor Unit (VPU) comprising first vector lane circuitry including first matrix multiplier circuitry, second vector lane circuitry including second matrix multiplier circuitry, and interconnect circuitry to connect the first vector lane circuitry and the second vector lane circuitry in a ring structure.

Example 2 includes the VPU of example 1, wherein the first matrix multiplier circuitry includes first vector register fragment circuits to store first input matrix data, the first matrix multiplier circuitry to generate a first partial result based on the first input matrix data, and the second matrix multiplier circuitry includes second vector register fragment circuits to store second input matrix data, the second matrix multiplier circuitry to generate a second partial result based on the second input matrix data, the first matrix multiplier circuitry to generate the first partial result the second matrix multiplier circuitry to generate the second partial result in parallel.

Example 3 includes the VPU of one or more of example 2, wherein the first input matrix data and the second input matrix data are a same portion of the input matrix data.

Example 4 includes the VPU of one or more of example 2, wherein the first input matrix data and the second input matrix data refer are different portions the input matrix data.

Example 5 includes the VPU of one or more of examples 2-4, wherein the first matrix multiplier circuitry includes column buffer circuitry to access a first portion of the first input matrix data from a first one or more of the first vector register fragment circuits, row buffer circuitry to access a second portion of the first input matrix data from a second one or more of the first vector register fragment circuits, and a first Multiply and Accumulate (MAC) circuit to multiply a first entry from a column of the column buffer circuitry with a second entry from a row of the row buffer circuitry, and add a product from the multiplication to a partial result determined during a previous iteration of the MAC circuit.

Example 6 includes the VPU of example 5, wherein the first entry includes a single data element, and the multiplication of the first entry and the second entry corresponds to a rank-one update.

Example 7 includes the VPU of examples 5, wherein the first entry includes a vector with two data elements, and the multiplication of the first entry and the second entry corresponds to a rank-two update.

Example 8 includes the VPU of one or more of examples 5-7, wherein the product is one of a first plurality of products generated concurrently by a plurality of MAC circuits including the first MAC circuit, the first plurality of products corresponding to a first column of data from the column buffer circuitry and a row of data from the row buffer circuitry, and the first matrix multiplier circuitry is to, after generating the first plurality of products transmit the first column of data to the second vector lane circuit, obtain a second column of data from third vector lane circuitry, and generate a second plurality of products by multiplying, with the plurality of MAC circuits, the second column of data from the third vector lane circuit with the row of data from the row buffer circuitry.

Example 9 includes the VPU of example 8, wherein the first matrix multiplier circuitry is to multiply a third column of data with the row of data before generating the second plurality of products, the third column of data stored in the column buffer circuitry before the second column of data was received.

Example 10 includes the VPU of one or more of examples 1-9, wherein the second vector lane circuitry is one or more of (i) a next vector lane circuit in a sequence, or (ii) a preceding vector lane circuit in the sequence.

Example 11 includes the VPU of one or more of examples 1-10, wherein the first matrix multiplier circuitry includes accumulator memory to store a sum of the product and the partial result.

Example 12 includes the VPU of one or more of examples 5-11, wherein the first matrix multiplier circuitry is to store a sum of the product and the partial result in one of the first vector register fragments.

Example 13 includes an apparatus comprising interface circuitry, machine-readable instructions stored in accessible memory, and at least one programmable circuit to be programmed based on the machine-readable instructions to provide matrix dimensions to a Vector Processing Unit (VPU), the matrix dimensions corresponding to a first input matrix, a second input matrix, and an output matrix, obtain tile dimensions from the VPU based on the matrix dimensions, the tile dimensions including dimensions of first input tiles that correspond to the first input matrix, dimensions of second input tiles that correspond to the second input matrix, and dimensions of output tiles that correspond to the output matrix, the tile dimensions smaller than the matrix dimensions, configure the VPU based on the tile dimensions and the matrix dimensions, and instruct the configured VPU to populate the output matrix based on multiplication of ones of the first input tiles and ones of the second input tiles.

Example 14 includes the apparatus of example 13, wherein one or more of the at least one programmable circuit is to define the matrix dimensions based on a user space program.

Example 15 includes the apparatus of one or more of examples 13-14, wherein the VPU includes first vector lane circuitry including a first buffer and first matrix multiplier circuitry, and second vector lane circuitry including a second buffer and second matrix multiplier circuitry.

Example 16 includes the apparatus of one or more of examples 13-15, wherein to configure the VPU, one or more of the at least one the programmable circuit is to provide a first operand to the first vector lane circuitry and the second vector lane circuit, the first operand corresponding to first data from the first input matrix, instruct the first matrix multiplier circuitry to perform a first multiplication based on the first operand and a second operand, the second operand corresponding to second data from the second input matrix, and instruct the second matrix multiplier circuitry to perform a second multiplication based on the first operand and a third operand, the second multiplication to be performed concurrently with the first multiplication, the third operand corresponding to third data from the second input matrix, the third data different from the second data.

Example 17 includes the apparatus of one or more of examples 13-15, wherein to configure the VPU, one or more of the at least one programmable circuit is to instruct the first matrix multiplier circuitry to perform a first multiplication based on a first operand and a second operand, the first operand corresponding to first data from the first input matrix and the second operand corresponding to second data from the second input matrix, instruct the second matrix multiplier circuitry to perform a second multiplication based on a third operand and a fourth operand, the second multiplication to occur concurrently with the first multiplication, the third operand corresponding to third data from the first input matrix, the third data different from the first data, the fourth operand corresponding to fourth data from the second input matrix, the fourth data different from the second data, instruct, after the first multiplication and the second multiplication, the first matrix multiplier circuitry to perform a third multiplication based on the third operand and the second operand, and instruct, after the first multiplication and the second multiplication, the second matrix multiplier circuitry to perform a fourth multiplication based on the first operand and the fourth operand.

Example 18 includes the apparatus of one or more of examples 16-17, wherein to configure the VPU, one or more of the at least one programmable circuit is to during the first multiplication, instruct the first vector lane circuitry to rotate a first column of data from the first operand to the second vector lane circuitry after the first column of data is processed by the first matrix multiplier circuitry, and during the second multiplication, instruct the second vector lane circuitry to rotate a second column of data from the third operand to the first vector lane circuitry after the second column of data is processed by the second matrix multiplier circuitry.

Example 19 includes the apparatus of example 18, wherein to configure the VPU, one or more of the at least one programmable circuit is to instruct the first vector lane circuitry to store the second column of data in the first buffer until the first multiplication is complete, and instruct the second vector lane circuitry to store the first column of data in the second buffer until the second multiplication is complete.

Example 20 includes the apparatus of one or more of examples 13-19, wherein to configure the VPU, one or more of the at least one programmable circuit is to instruct the VPU to multiply the ones of the first input tiles and the ones of the second input tiles according to an outer product technique.

Example 21 includes the apparatus of one or more of examples 13-20, wherein to configure the VPU, one or more of the at least one programmable circuit is to instruct the VPU to multiply ones of the first input tiles and ones of the second input tiles according to an inner product technique.

Example 22 includes a method comprising providing matrix dimensions to a Vector Processing Unit (VPU), the matrix dimensions corresponding to a first input matrix, a second input matrix, and an output matrix, obtaining tile dimensions from the VPU based on the matrix dimensions, the tile dimensions including dimensions of first input tiles that correspond to the first input matrix, dimensions of second input tiles that correspond to the second input matrix, and dimensions of output tiles that correspond to the output matrix, the tile dimensions smaller than the matrix dimensions, configuring the VPU based on the tile dimensions and the matrix dimensions, and instructing the configured VPU to populate the output matrix based on multiplication of ones of the first input tiles and ones of the second input tiles

Example 23 includes the method of example 22, including defining the matrix dimensions based on a user space program.

Example 24 includes the method of one or more of examples 22-23, wherein the VPU includes first vector lane circuitry including a first buffer and first matrix multiplier circuitry, and second vector lane circuitry including a second buffer and second matrix multiplier circuitry.

Example 25 includes the method of one or more of examples 22-24, wherein configuring the VPU includes: providing a first operand to the first vector lane circuitry and the second vector lane circuit, the first operand corresponding to first data from the first input matrix, instructing the first matrix multiplier circuitry to perform a first multiplication based on the first operand and a second operand, the second operand corresponding to second data from the second input matrix, and instructing the second matrix multiplier circuitry to perform a second multiplication based on the first operand and a third operand, the second multiplication to be performed concurrently with the first multiplication, the third operand corresponding to third data from the second input matrix, the third data different from the second data.

Example 26 includes the method of one or more of examples 22-24, wherein configuring the VPU includes: instructing the first matrix multiplier circuitry to perform a first multiplication based on a first operand and a second operand, the first operand corresponding to first data from the first input matrix and the second operand corresponding to second data from the second input matrix; instructing the second matrix multiplier circuitry to perform a second multiplication based on a third operand and a fourth operand, the second multiplication to occur concurrently with the first multiplication, the third operand corresponding to third data from the first input matrix, the third data different from the first data, the fourth operand corresponding to fourth data from the second input matrix, the fourth data different from the second data, instructing, after the first multiplication and the second multiplication, the first matrix multiplier circuitry to perform a third multiplication based on the third operand and the second operand, and instructing, after the first multiplication and the second multiplication, the second matrix multiplier circuitry to perform a fourth multiplication based on the first operand and the fourth operand.

Example 27 includes the method of one or more of examples 25-26, wherein configuring the VPU incudes: during the first multiplication, instructing the first vector lane circuitry to rotate a first column of data from the first operand to the second vector lane circuitry after the first column of data is processed by the first matrix multiplier circuitry, and during the second multiplication, instructing the second vector lane circuitry to rotate a second column of data from the third operand to the first vector lane circuitry after the second column of data is processed by the second matrix multiplier circuitry.

Example 28 includes the method of example 27, wherein configuring the VPU incudes: instructing the first vector lane circuitry to store the second column of data in the first buffer until the first multiplication is complete, and instructing the second vector lane circuitry to store the first column of data in the second buffer until the second multiplication is complete.

Example 29 includes the method of one or more of examples 22-28, wherein configuring the VPU includes instructing the VPU to multiply the ones of the first input tiles and the ones of the second input tiles according to an outer product technique.

Example 30 includes the method of one or more of examples 22-29, wherein configuring the VPU includes instructing the VPU to multiply the ones of the first input tiles and the ones of the second input tiles according to an inner product technique.

Example 31 includes an apparatus comprising means for implementing matrix multiplication, and means for coordinating matrix multiplication to provide matrix dimensions to the means for implementing, the matrix dimensions corresponding to a first input matrix, a second input matrix, and an output matrix, obtain tile dimensions from the means for implementing, the tile dimensions based on the matrix dimensions, the tile dimensions including dimensions of first input tiles that correspond to the first input matrix, dimensions of second input tiles that correspond to the second input matrix, and dimensions of output tiles that correspond to the output matrix, the tile dimensions smaller than the matrix dimensions, configure the means for implementing based on the tile dimensions and the matrix dimensions, and instruct the configured means for implementing to populate the output matrix based on multiplication of ones of the first input tiles and ones of the second input tiles.

Example 32 includes the apparatus of example 31, wherein the means for coordinating is to define the matrix dimensions based on a user space program.

Example 33 includes the apparatus of one or more of examples 31-32, wherein the means for implementing includes first vector lane circuitry including a first buffer and first matrix multiplier circuitry, and second vector lane circuitry including a second buffer and second matrix multiplier circuitry.

Example 34 includes the apparatus of one or more of examples 31-33, wherein to configure the means for implementing, the means for coordinating is to provide a first operand to the first vector lane circuitry and the second vector lane circuit, the first operand corresponding to first data from the first input matrix, instruct the first matrix multiplier circuitry to perform a first multiplication based on the first operand and a second operand, the second operand corresponding to second data from the second input matrix, and instruct the second matrix multiplier circuitry to perform a second multiplication based on the first operand and a third operand, the second multiplication to be performed concurrently with the first multiplication, the third operand corresponding to third data from the second input matrix, the third data different from the second data.

Example 35 includes the apparatus of one or more of examples 31-33, wherein to configure the means for implementing, the means for coordinating is to instruct the first matrix multiplier circuitry to perform a first multiplication based on a first operand and a second operand, the first operand corresponding to first data from the first input matrix and the second operand corresponding to second data from the second input matrix, instruct the second matrix multiplier circuitry to perform a second multiplication based on a third operand and a fourth operand, the second multiplication to occur concurrently with the first multiplication, the third operand corresponding to third data from the first input matrix, the third data different from the first data, the fourth operand corresponding to fourth data from the second input matrix, the fourth data different from the second data, instruct, after the first multiplication and the second multiplication, the first matrix multiplier circuitry to perform a third multiplication based on the third operand and the second operand, and instruct, after the first multiplication and the second multiplication, the second matrix multiplier circuitry to perform a fourth multiplication based on the first operand and the fourth operand.

Example 36 includes the apparatus of one or more of examples 34-35, wherein to configure the means for implementing, the means for coordinating is to during the first multiplication, instruct the first vector lane circuitry to rotate a first column of data from the first operand to the second vector lane circuitry after the first column of data is processed by the first matrix multiplier circuitry, and during the second multiplication, instruct the second vector lane circuitry to rotate a second column of data from the third operand to the first vector lane circuitry after the second column of data is processed by the second matrix multiplier circuitry.

Example 37 includes the apparatus of examples 36, wherein to configure the means for implementing, the means for coordinating is to instruct the first vector lane circuitry to store the second column of data in the first buffer until the first multiplication is complete, and instruct the second vector lane circuitry to store the first column of data in the second buffer until the second multiplication is complete.

Example 38 includes the apparatus of one or more of examples 31-37, wherein to configure the means for implementing, the means for coordinating is to instruct the means for implementing to multiply the ones of the first input tiles and the ones of the second input tiles according to an outer product technique.

Example 39 includes the apparatus of one or more of examples 31-38, wherein to configure the means for implementing, the means for coordinating is to instruct the means for implementing to multiply the ones of the first input tiles and the ones of the second input tiles according to an inner product technique.

Example 40 includes a Vector Processor Unit (VPU) comprising interface circuitry, machine-readable instructions, and at least one programmable circuit to be programmed based on the machine-readable instructions to obtain matrix dimensions from a user space program, the matrix dimensions corresponding to a first input matrix, a second input matrix, and an output matrix, determine tile dimensions based on the matrix dimensions, the tile dimensions including dimensions of first input tiles that correspond to the first input matrix, dimensions of second input tiles that correspond to the second input matrix, and dimensions of output tiles that correspond to the output matrix, the tile dimensions are smaller than the matrix dimensions, populate the output tiles based on multiplication of ones of the first input tiles and ones of the second input tiles in a configuration determined by the user space program, and populate the output matrix based on the populated output tiles.

Example 41 includes the VPU of example 40, wherein the VPU includes a plurality of vector lane circuits and a plurality of vector registers, a first one of the vector lane circuits includes vector register fragment circuits and matrix multiplier circuitry, the vector register fragment circuits to store data from a first one of the plurality of vector registers.

Example 42 includes the VPU of one or more of examples 40-41, wherein the VPU is to determine the tile dimensions to cause at least one of the first input tile or the second input tile to fit within one or more of the vector registers.

Example 43 includes the VPU of one or more of examples 40-42, wherein the matrix multiplier circuitry includes a plurality of Multiply And Accumulate (MAC) circuits arranged in a grid, and the VPU is to determine the tile dimensions based on a number of rows and a number of columns in the grid of MAC circuits.

Example 44 includes the VPU of one or more of examples 40-43, wherein the VPU is to determine the tile dimensions to cause the first input tiles to fit within the first input matrix, and a number of sub-tiles per tile is evenly divisible by a number of vector lanes assigned to the matrix multiplication.

Example 45 includes a method comprising obtaining matrix dimensions from a user space program, the matrix dimensions corresponding to a first input matrix, a second input matrix, and an output matrix, determining tile dimensions based on the matrix dimensions, the tile dimensions including dimensions of first input tiles that correspond to the first input matrix, dimensions of second input tiles that correspond to the second input matrix, and dimensions of output tiles that correspond to the output matrix, the tile dimensions are smaller than the matrix dimensions, populating, with a Vector Processor Unit (VPU), the output tiles based on multiplication of ones of the first input tiles and ones of the second input tiles in a configuration determined by the user space program, and populating, with the VPU, the output matrix based on the populated output tiles.

Example 46 includes the method of example 45, wherein: the VPU includes a plurality of vector lane circuits and a plurality of vector registers, a first one of the vector lane circuits includes vector register fragment circuits and matrix multiplier circuitry, and the method includes storing, with the vector register fragment circuits, data from a first one of the plurality of vector registers.

Example 47 includes the method of one or more of examples 45-46, including determining the tile dimensions to cause at least one of the first input tile or the second input tile to fit within one or more of the vector registers.

Example 48 includes the method of one or more of examples 45-47, wherein: the matrix multiplier circuitry includes a plurality of Multiply And Accumulate (MAC) circuits arranged in a grid, and the method includes determining the tile dimensions based on a number of rows and a number of columns in the grid of MAC circuits.

Example 49 includes the method of one or more of examples 45-48, including determining the tile dimensions to cause: the first input tiles to fit within the first input matrix, and a number of sub-tiles per tile is evenly divisible by a number of vector lanes assigned to the matrix multiplication.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A Vector Processor Unit (VPU) comprising:
first vector lane circuitry including first matrix multiplier circuitry;
second vector lane circuitry including second matrix multiplier circuitry; and
interconnect circuitry to connect the first vector lane circuitry and the second vector lane circuitry in a ring structure.

2. The VPU of claim 1, wherein:
the first matrix multiplier circuitry includes first vector register fragment circuits to store first input matrix data, the first matrix multiplier circuitry to generate a first partial result based on the first input matrix data; and
the second matrix multiplier circuitry includes second vector register fragment circuits to store second input matrix data, the second matrix multiplier circuitry to generate a second partial result based on the second input matrix data, the first matrix multiplier circuitry to generate the first partial result the second matrix multiplier circuitry to generate the second partial result in parallel.

3. The VPU of claim 2, wherein the first input matrix data and the second input matrix data are a same portion of input matrix data.

4. The VPU of claim 2, wherein the first input matrix data and the second input matrix data are different portions of input matrix data.

5. The VPU of claim 2, wherein the first matrix multiplier circuitry includes:
column buffer circuitry to access a first portion of the first input matrix data from a first one or more of the first vector register fragment circuits;
row buffer circuitry to access a second portion of the first input matrix data from a second one or more of the first vector register fragment circuits; and
a first Multiply and Accumulate (MAC) circuit to:
multiply a first entry from a column of the column buffer circuitry with a second entry from a row of the row buffer circuitry; and
add a product from the multiplication to a partial result determined during a previous iteration of the MAC circuit.

6. The VPU of claim 5, wherein:
the first entry includes a single data element; and
the multiplication of the first entry and the second entry corresponds to a rank-one update.

7. The VPU of claim 5, wherein:
the first entry includes a vector with two data elements; and
the multiplication of the first entry and the second entry corresponds to a rank-two update.

8. The VPU of claim 5, wherein:
the product is one of a first plurality of products generated concurrently by a plurality of MAC circuits including the first MAC circuit, the first plurality of products corresponding to a first column of data from the column buffer circuitry and a row of data from the row buffer circuitry; and
the first matrix multiplier circuitry is to, after generating the first plurality of products:
transmit the first column of data to the second vector lane circuitry;
obtain a second column of data from third vector lane circuitry; and
generate a second plurality of products by multiplying, with the plurality of MAC circuits, the second column of data from the third vector lane circuitry with the row of data from the row buffer circuitry.

9. The VPU of claim 8, wherein the first matrix multiplier circuitry is to multiply a third column of data with the row of data before generating the second plurality of products, the third column of data stored in the column buffer circuitry before the second column of data was received.

10. The VPU of claim 8, wherein the second vector lane circuitry is one or more of (i) a next instance of vector lane circuitry in the ring structure, or (ii) a preceding instance of vector lane circuitry in the ring structure.

11. The VPU of claim 5, wherein the first matrix multiplier circuitry includes accumulator memory to store a sum of the product and the partial result.

12. The VPU of claim 5, wherein the first matrix multiplier circuitry is to store a sum of the product and the partial result in one of the first vector register fragment circuits.

13.-39. (canceled)

40. A Vector Processing Unit (VPU) comprising:
interface circuitry;
machine-readable instructions stored in accessible memory; and
at least one programmable circuit to be programmed based on the machine-readable instructions to:
obtain matrix dimensions from a user space program, the matrix dimensions corresponding to a first input matrix, a second input matrix, and an output matrix;
determine tile dimensions based on the matrix dimensions, the tile dimensions including dimensions of first input tiles that correspond to the first input matrix, dimensions of second input tiles that correspond to the second input matrix, and dimensions of output tiles that correspond to the output matrix, the tile dimensions are smaller than the matrix dimensions;
populate the output tiles based on multiplication of ones of the first input tiles and ones of the second input tiles in a configuration determined by the user space program; and
populate the output matrix based on the populated output tiles.

41. The VPU of claim 40, wherein the VPU includes a plurality of vector lane circuits and a plurality of vector registers, a first one of the vector lane circuits includes vector register fragment circuits and matrix multiplier circuitry, the vector register fragment circuits to store data from a first one of the plurality of vector registers.

42. The VPU of claim 41, wherein the VPU is to determine the tile dimensions to cause at least one of the first input tiles or the second input tiles to fit within one or more of the vector registers.

43. The VPU of claim 41, wherein:
the matrix multiplier circuitry includes a plurality of Multiply And Accumulate (MAC) circuits arranged in a grid; and
the VPU is to determine the tile dimensions based on a number of rows and a number of columns in the grid of MAC circuits.

44. The VPU of claim 41, wherein the VPU is to determine the tile dimensions to cause:
the first input tiles to fit within the first input matrix; and
a number of sub-tiles per tile is evenly divisible by a number of vector lanes assigned to the matrix multiplication.

45.-49. (canceled)

50. A non-transitory machine readable storage medium comprising instructions to cause programmable circuitry to at least:
obtain matrix dimensions from a user space program, the matrix dimensions corresponding to a first input matrix, a second input matrix, and an output matrix;
determine tile dimensions based on the matrix dimensions, the tile dimensions including dimensions of first input tiles that correspond to the first input matrix, dimensions of second input tiles that correspond to the second input matrix, and dimensions of output tiles that correspond to the output matrix, the tile dimensions are smaller than the matrix dimensions;
populate the output tiles based on multiplication of ones of the first input tiles and ones of the second input tiles in a configuration determined by the user space program; and
populate the output matrix based on the populated output tiles.

51. The non-transitory machine readable storage medium of claim 50, wherein the programmable circuitry includes a plurality of vector lane circuits and a plurality of vector registers, a first one of the vector lane circuits includes vector register fragment circuits and matrix multiplier circuitry, the vector register fragment circuits to store data from a first one of the plurality of vector registers.

52. The non-transitory machine readable storage medium of claim 51, wherein the programmable circuitry is to determine the tile dimensions to cause at least one of the first input tiles or the second input tiles to fit within one or more of the vector registers.

53. The non-transitory machine readable storage medium of claim 51, wherein: the matrix multiplier circuitry includes a plurality of Multiply And Accumulate (MAC) circuits arranged in a grid; and
the programmable circuitry is to determine the tile dimensions based on a number of rows and a number of columns in the grid of MAC circuits.

54. The non-transitory machine readable storage medium of claim 51, wherein the programmable circuitry is to determine the tile dimensions to cause:
the first input tiles to fit within the first input matrix; and
a number of sub-tiles per tile is evenly divisible by a number of vector lanes assigned to the matrix multiplication.
